(19) United States
(12) Patent Application Publication
(10) Pub. No.: US 2017/0148264 A1
(43) Pub. Date: May 25, 2017

(54) SYSTEM AND METHOD FOR MANAGING BEHAVIOR

(71) Applicant: KINDERGUARDIAN INC., Moncton (CA)

(72) Inventors: Matthew Raymond PICHETTE, Moncton (CA); Melani FLANAGAN, Moncton (CA)

(21) Appl. No.: 15/319,049

(22) PCT Filed: Jun. 16, 2015
(86) PCT No.: PCT/CA2015/000385

§ 371 Date: Dec. 15, 2016

Related U.S. Application Data
(60) Provisional application No. 62/012,742, filed on Jun. 16, 2014.

(51) Int. Cl. G07F 17/32; G06Q 20/06; G06Q 20/12; G06Q 30/02

(52) U.S. Cl. CPC G07F 17/3244; G07F 17/3272; G07F 17/3227; G07F 17/3255; G07F 17/3269; G07F 17/3262; G06Q 30/0209; G06Q 20/06; G06Q 20/123

(57) ABSTRACT

A system is provided for applying one or more rule sets for managing behavior. These rule sets may be defined, for example, to enforce monetary limits, monetary usage, usage policies, reporting, use of virtual currency, etc. The one or more rule sets may be defined by one or more users, such as supervisors, to manage the behavior of one or more users, such as supervisees. The one or more rule sets may operate in the context of various electronic and/or computer-related devices, such as mobile applications, desktop applications, the purchase of media, content, in-application purchases, virtual currency, virtual commodities, etc.

### FIELD

The present disclosure relates generally to electronic and/or computer applications, and more particularly to systems and methods for managing behavior.

### BACKGROUND

In the context of applications that run on various software and/or hardware platforms, the economic model related to the sales of applications, services, etc., may have shifted from traditional brick and mortar stores. The business models utilized in selling the applications may vary—for example, applications may charge users through the sales of licenses for the applications, on a subscription basis, through purchasing/unlocking features, virtual currency, bonuses, virtual items, etc.

In the context of the gaming industry, many games have switched to a “Free-to-Play” economic model where many games are free; with these games, the necessity to limit spending may not be readily apparent as purchases may be conducted by choice, as opposed to being a necessity. For example, to complete a particular level in a game, a user may be required to build a “building”, which requires “wood” resources, which require a “lumber mill” which requires using “diamonds” that may be found or earned but may be conveniently available in exchange for “gold” which can be purchased with real money.

The economic model is not limited to games, other types of applications, such as educational focused products, have been utilizing non-traditional business models.

A challenge that arises is the need to monitor and enforce spending policies; especially given the variety of platforms, business models and/or products in the market.

### SUMMARY

The present disclosure relates generally to electronic and/or computer applications, and more particularly to systems and methods for setting rules and managing behavior in applications.

In a first aspect, a computer-implemented method is provided for managing behaviors of at least one user of one or more electronic applications, comprising: receiving a set of electronic instructions defining (i) one or more virtual currency limits defining constraints or permissions related to the operation of the one or more electronic applications, each virtual currency limit associated with each of the at least one user, and (ii) a set of triggers based on least one of patterns of positive gaming behavior to incentivize and patterns of negative gaming behavior to penalize; periodically receiving, at a computing device, electronic indicia of activities performed by the at least one user associated with the one or more electronic applications; determining, by the computing device, whether the electronic indicia of activities performed by the at least one user correspond to patterns of activity which trigger at least one of the set of triggers; modifying the one or more virtual currency limits based at least in part in the determination that at least one of the set of triggers has been triggered; wherein modifying the one or more virtual currency limits includes (i) increasing a virtual currency limit if the trigger triggered is associated with at least one of the patterns of behavior to incentivize, or (ii) decreasing a virtual currency limit if the trigger triggered is associated with at least one of the patterns of behavior to penalize. In another aspect, the method further comprises: receiving, at the computing device, electronic information representative of patterns of activities associated with an aggregate set of other users; wherein the determining, by the computing device, whether the electronic indicia of activities performed by the at least one users correspond to patterns of activities which trigger at least one of the set of triggers includes comparing the electronic information representative of patterns of activities associated with the aggregate set of other users with the electronic indicia of activities performed by the at least one users; and wherein the set of triggers includes at least triggers based on deviations from the patterns of activities associated with the aggregate set of other users.

In another aspect, the method further comprises: generating one or more visual representations of patterns of activities of the one or more users compared with the electronic information representative of patterns of activities associated with the aggregate set of other users with the electronic indicia of activities performed by the at least one users; and generating one or more visual representations of a fluctuation of the one or more virtual currency limits over a period of time.

In another aspect, the steps of receiving a set of electronic instructions defining (i) one or more virtual currency limits defining constraints or permissions related to the operation of the one or more electronic applications, each virtual currency limit associated with each of the at least one user, and (ii) a set of triggers based on least one of patterns of positive gaming behavior to incentivize and patterns of negative gaming behavior to penalize; periodically receiving, at a computing device, electronic indicia of activities performed by the at least one user associated with the one or more electronic applications; determining, by the computing device, whether the electronic indicia of activities performed by the at least one user correspond to patterns of activity which trigger at least one of the set of triggers; and modifying the one or more virtual currency limits based at least in part in the determination that at least one of the set of triggers has been triggered; are performed by a computing device that is external to personal computing devices used by the one or more users.

In another aspect, the method further comprises: upon receiving electronic indicia representative of a pending electronic currency transaction invoked by the one or more users, applying the one or more virtual currency limits to terminate the pending electronic currency transaction if the pending electronic currency transaction would cause a breach of one or more of the one or more virtual currency limits.

In another aspect, the pending electronic currency transaction is an electronic transaction to purchase at least one of electronic goods and electronic services associated with the one or more applications.

In another aspect, the method further comprises: upon receiving electronic indicia representative of a pending electronic currency transaction invoked by the one or more users, applying the one or more virtual currency limits and generating a notification for transmission to a third party computing device if the pending electronic currency transaction would cause a breach of one or more of the one or more virtual currency limits.

In another aspect, the method further comprises: upon receiving electronic indicia representative of a pending electronic currency transaction invoked by the one or more users, applying the one or more virtual currency limits and generating a recommendation for an alternate currency transaction if the pending electronic currency transaction would cause a breach of one or more of the one or more virtual currency limits, the alternate currency transaction representing a second electronic currency transaction having a cost within the one or more virtual currency limits.

In another aspect, the modifying the one or more virtual currency limits consists of temporarily modifying the one or more virtual currency limits based at least in part in the determination that at least one of the set of triggers has been triggered.

In another aspect, the method further comprises: periodically providing, to a networked interface associated with the one or more electronic applications, the one or more virtual currency limits associated with the one or more users.

In another aspect, the method further comprises: receiving, from the networked interface associated with the one or more electronic applications, a set of potential transactions having prices less than the virtual currency limit associated with one of the one or more users.

In another aspect, the method further comprises: receiving, from the networked interface associated with the one or more electronic applications, a set of discounted potential transactions having prices less than the virtual currency limit associated with one of the one or more users.

In another aspect, the method further comprises: periodically providing, to a networked interface associated with a centralized system managing transactions associated with the one or more electronic applications, the one or more virtual currency limits associated with the one or more users.

In another aspect, the method further comprises: deactivating one or more user accounts associated with the one or more electronic applications, the one or more virtual currency limits associated with the one or more users.

In another aspect, the patterns of behaviors to incentivize and the patterns of behaviors to penalize include at least patterns of usage times.

In another aspect, default patterns of usage times are associated with the at least one users based on at least one characteristic of the one or more users.

In another aspect, the at least one characteristic includes at least one of age, gender, occupation, educational level and time zone.

In another aspect, the electronic currency transactions are associated with the purchase of at least one of in-game items, in-game services, virtual statuses, game purchases, in-game currency, unlockable products, and in-app purchases.

In another aspect, a computer-implemented system is provided for managing behaviors of at least one user of one or more electronic applications, the computer-implemented system including at least one processor and at least one non-transitory computer-readable media, the computer-implemented system residing on a computing device associated with the at least one user and the computer-implemented system comprising: a limit monitoring unit configured for tracking at least one virtual currency limit for the at least one user, each of the at least one virtual currency limit corresponding to each of the at least one user and defining constraints or permissions related to the operation of the one or more electronic applications; a rules program unit for generating and storing electronic rules defining track-able parameters representative of behaviors to be incentivized and behaviors to be penalized; a behavior tracking unit configured for tracking the behaviors of the at least one user, wherein the behaviors include at least one of physical location of the computing device, power state of the computing device, most recent activity of the at least one user on the computing device, data communications usage of the computing device, and usage times of the computing devices; a control unit configured for controlling the usage of the computing device by the at least one user by controlling at least one of the power state of the computing device, operation of the one or more electronic applications, and transactional activity on the one or more electronic applications; wherein a rules engine is configured to periodically apply the electronic rules based at least on tracked behaviors of a user tracked by the behavior tracking unit and to periodically modify the virtual currency limit for the user; and wherein upon a breach of the virtual currency limit for the user, the control unit is configured for terminating at least one of a pending transaction, the operation of the one or more electronic applications, and the power state of the computing device.

In another aspect, the system further comprises: a communications unit configured for communicating information and control instructions with a backend computing system, the backend computing system configured to interoperate with a plurality of communications units.

In another aspect, the backend computing system is provided as a distributed networking system.

In another aspect, a computer networked system is provided for managing behaviors of at least one user of one or more electronic applications, the computer networked system including at least one processor and at least one non-transitory computer-readable media, the computer networked system configured to communicate with a computing device associated with the at least one user and the computer-implemented system comprising: a limit monitoring unit configured for tracking at least one virtual currency limit for the at least one user, each of the at least one virtual currency limit corresponding to each of the at least one user and defining constraints or permissions related to the operation of the one or more electronic applications; a rules program unit for generating and storing electronic rules defining track-able parameters representative of behaviors to be incentivized and behaviors to be penalized; a behavior tracking unit configured for tracking the behaviors of the at least one user, wherein the behaviors include at least one of physical location of the computing device, power state of the computing device, most recent activity of the at least one user on the computing device, data communications usage of the computing device, and usage times of the computing devices; a control unit configured for controlling the usage of the computing device by the at least one user by controlling at least one of the power state of the computing device, operation of the one or more electronic applications, and transactional activity on the one or more electronic applications; wherein a rules engine is configured to periodically apply the electronic rules based at least on tracked behaviors of a user tracked by the behavior tracking unit and to periodically modify the virtual currency limit for the user; and wherein upon a breach of the virtual currency limit for the user, the control unit is configured for terminating at least one of a pending transaction, the operation of the one or more electronic applications, and the power state of the computing device.

In another aspect, a computer-implemented method is provided for managing behaviors of at least one user of one or more electronic applications, comprising: receiving a set of electronic instructions defining (i) one or more virtual time limits defining constraints or permissions related to the operation of the one or more electronic applications, each virtual time limit associated with each of the at least one user, and (ii) a set of triggers based on least one of patterns of positive gaming behavior to incentivize and patterns of negative gaming behavior to penalize; periodically receiving, at a computing device, electronic indicia of activities performed by the at least one user associated with the one or more electronic applications; determining, by the computing device, whether the electronic indicia of activities performed by the at least one user correspond to patterns of activity which trigger at least one of the set of triggers; modifying the one or more virtual time limits based at least in part in the determination that at least one of the set of triggers has been triggered; wherein modifying the one or more virtual time limits includes (i) increasing a virtual time limit if the trigger triggered is associated with at least one of the patterns of behavior to incentivize, or (ii) decreasing a virtual time limit if the trigger triggered is associated with at least one of the patterns of behavior to penalize.

In another aspect, the virtual time limits include one or more inclusionary time durations.

In another aspect, the virtual time limits include one or more exclusionary time durations.

In another aspect, the virtual time limits include both one or more exclusionary time durations and one or more inclusionary time durations.

In some embodiments, various combinations and/or permutations of the above configurations are provided by the system.

In various further aspects, the disclosure provides corresponding systems and devices, and logic structures such as machine-executable coded instruction sets for implementing such systems, devices, and methods.

In this respect, before explaining at least one embodiment in detail, it is to be understood that the present disclosure is not limited in its application to the details of construction and to the arrangements of the components set forth in the following description or illustrated in the drawings. The present disclosure is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments are illustrated by way of example. It may be to be expressly understood that the description and drawings are only for the purpose of illustration and as an aid to understanding, and are not intended as a definition of the limits.

Embodiments will now be described, by way of example only, with reference to the attached figures, wherein:

FIG. 1 is a deployment diagram outlining the component breakdown within the logical API System, according to some embodiments.

FIG. 2 is a deployment diagram outlining the component breakdown within the logical Analytics System, according to some embodiments.

FIG. 3 is a deployment diagram outlining the component breakdown amongst the logical system, according to some embodiments.

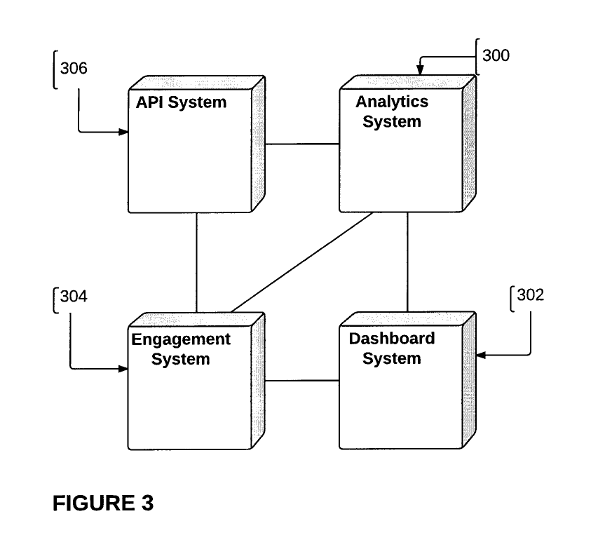

FIG. 4 is a deployment diagram outlining the component breakdown within the logical Dashboard System, according to some embodiments.

FIG. 5 is a deployment diagram outlining the component breakdown within the logical Engagement System, according to some embodiments.

FIG. 6 is an object diagram showing the object and class structure for monetary and time limits, according to some embodiments.

FIG. 7 is an object diagram showing the object and class structure for exclusionary and inclusionary time periods, according to some embodiments.

FIG. 8 is a flow chart illustrating the system behavior when an application session crosses into an exclusionary time window, according to some embodiments.

FIG. 9 is a flow chart illustrating the system behavior when an application session starts during an exclusionary time window, according to some embodiments.

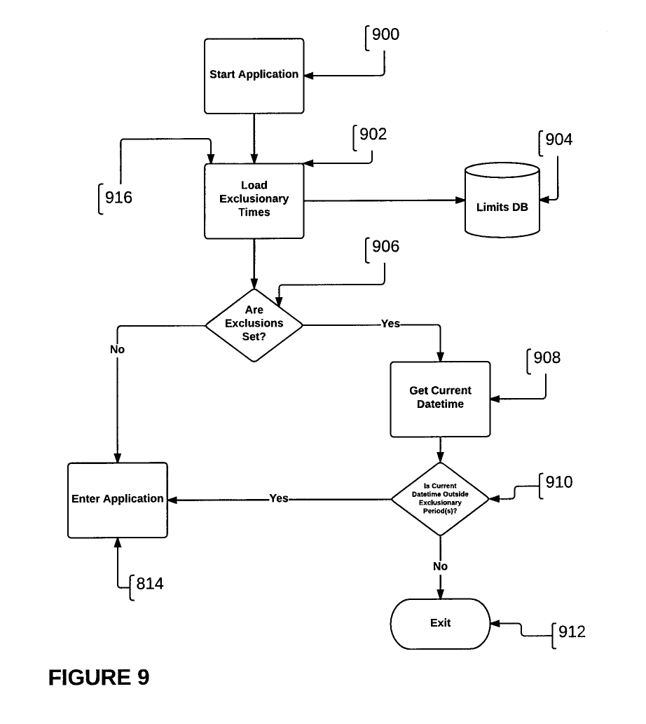

FIG. 10 is a flow chart illustrating the system behavior when the application enforces monetary limits, according to some embodiments.

FIG. 11 is a flow chart illustrating a user setting a single application time limit renewal period. This illustration is referenced by FIG. 25, according to some embodiments.

FIG. 12 is a flow chart illustrating a user setting a global application time limit renewal period. This illustration is referenced by FIG. 24, according to some embodiments.

FIG. 13 is a flow chart illustrating a user setting application time exclusion periods, according to some embodiments.

FIG. 14 is a flow chart illustrating a user setting a single application monetary limit renewal period. This illustration is referenced by FIG. 17, according to some embodiments.

FIG. 15 is a flow chart illustrating a user setting a global application monetary limit renewal period. This illustration is referenced by FIG. 16, according to some embodiments.

FIG. 16 is a flow chart illustrating a user setting a global monetary limit for applications. This illustration references FIG. 15, according to some embodiments.

FIG. 17 is a flow chart illustrating a user setting a monetary limit for a single application. This illustration references FIG. 14, according to some embodiments.

FIG. 18 is a flowchart illustrating a user rewarding or penalizing a user by increasing or decreasing limits temporarily, according to some embodiments.

FIG. 19 is a physical layout illustrating the interaction of various system components, system environments, and user environments, according to some embodiments.

FIG. 20 is a wireframe diagram illustrating an error message a supervisee may encounter when attempting to make a purchase where the price is higher than the remaining limit balance, according to some embodiments.

FIG. 21 is a wireframe diagram illustrating an in-app user interface displaying an engagement notification to inform the supervisee when the limit renewal is scheduled to occur, according to some embodiments.

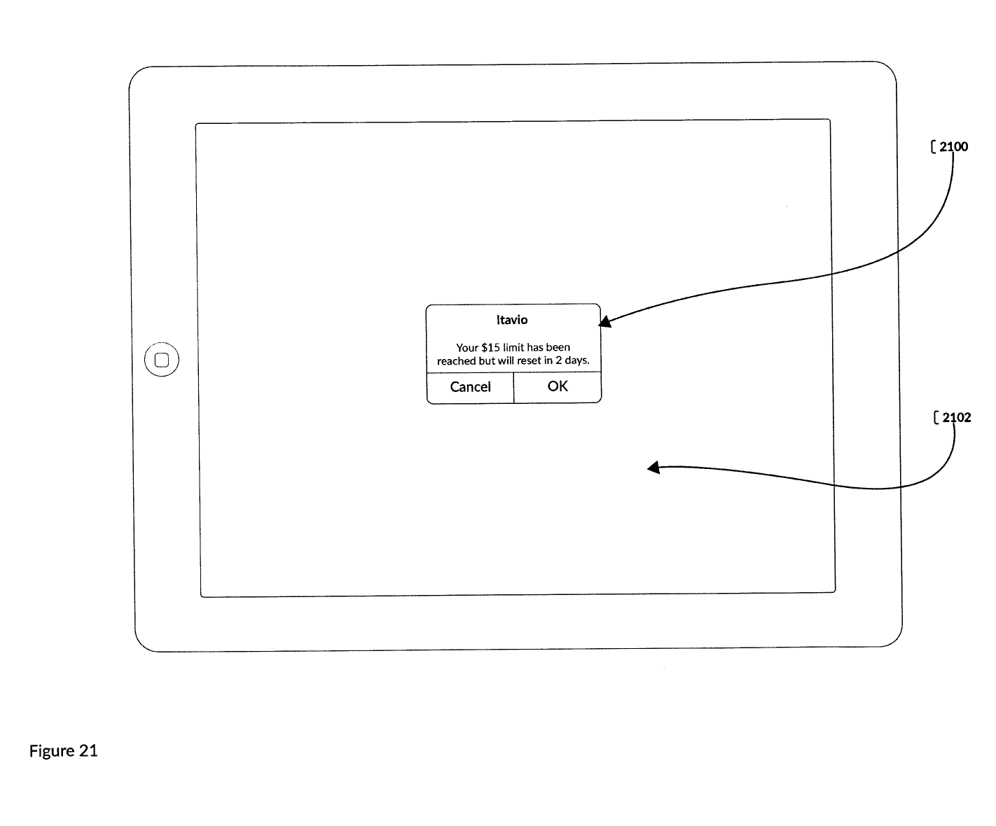

FIG. 22 is a wireframe diagram illustrating an in-app user interface that a supervisor may use to login or create an account, according to some embodiments.

FIG. 23 is a wireframe diagram illustrating an in-app user interface that a supervisor may use to set monetary limits, according to some embodiments.

FIG. 24 is a flow chart illustrating a user setting a global time limit for various applications. This illustration references FIG. 12, according to some embodiments.

FIG. 25 is a flow chart illustrating a user setting a time limit for a single application. This illustration references FIG. 11, according to some embodiments.

FIG. 26 is a flow chart illustrating the system behavior when the application enforces time limits, according to some embodiments.

FIG. 27 is a flow chart illustrating a user setting their application notification preferences, according to some embodiments.

FIG. 28 is an object diagram showing the object and class structure for applications, developers, developer user and normal user accounts, according to some embodiments.

FIG. 29 is a wireframe diagram illustrating an example of a dashboard application and a few of the visualizations available, according to some embodiments.

FIG. 30 is a wireframe diagram illustrating an example of a mobile monitoring and management application, according to some embodiments.

FIG. 31 is an object diagram showing the object and class structure for virtual currency accounts, according to some embodiments.

FIG. 32 is a schematic diagram of a computing device, which may be used in the implementation of the system, according to some embodiments.

### DETAILED DESCRIPTION

Preferred embodiments of methods, systems, and apparatus suitable for use in implementing the present disclosure are described through reference to the drawings.

The present disclosure, in one aspect, provides a system for monitoring the spending behavior of users.

It will be appreciated by those skilled in the art that other variations of the embodiments described herein may also be practiced. Other modifications are therefore possible.

In some embodiments, a system may be described that helps manage an individual's behaviors and to help prevent engagement in unauthorized behaviors on games, educational applications, media and entertainment applications, or any other application running in, with access to, distributed by, or connected to a payment provider, platform, and/or “app store”.

The individuals may include a wide variety of users, such as children, adults, employees, students, etc.

Behaviors may include various behaviors, including, but not limited to, playing of applications, purchasing of applications, using of applications, making purchases through the application (“in-app purchases”, e.g. to unlock features, purchase media, purchase content, purchase virtual currency, purchase accessories), purchasing of subscriptions, setting various renewal policies, purchasing consumables, purchasing non-consumables, etc.

Behaviors may have various characteristics based on the context in which the behavior is performed, such as the time of the behavior, whether particular policies are in place, how often the behavior has occurred/not occurred, the total elapsed period of time in relation to the behavior.

For example, as described further in this specification, various computer-implemented methods, systems, and non-transitory computer readable media having instructions stored upon are provided in relation to the management of user behavior.

### Rules Engine

The system may be configured for the ability to set, monitor, and/or enforce various policies which may provide a set of rules for which unauthorized behaviors can be defined, monitored and/or enforced. As a simple, non-limiting, illustrative example, the system may be configured such that a child is not able to play a particular game after 8 pm. The policies may be configured and/or set up as triggers, for example, logical conditions which set out when an action should be taken or not taken.

The system may be configured to include a rules engine that may store one or more rules for application and/or enforcement as various behaviors may be monitored. These one or more rules may govern elements related to behavior and may be comprised of various types of business logic, which may include elements such as triggers, preconditions, events, time ranges, date ranges, etc. The one or more rules may be predefined and/or defined in an ad hoc fashion by one or more users. Rules may be applied globally or locally, and/or at a group level, etc. The rules may be stored as various sets of logical, electronic instructions, that may define a set of triggers based on least one of patterns of positive gaming behavior to incentivize and patterns of negative gaming behavior to penalize.

In some embodiments, the rules engine may be configured for the debiting and/or crediting of monetary limits.

In some embodiments, the rules engine may be configured for controlling various elements of an application and/or game, such as preventing a user from playing a game, preventing in-game purchases, and in further embodiments, is able to interact with a game (e.g. the game may detect that the behavior of the user has been good and accordingly provides awards to the user).

The rules engine may be configured to interoperate with various components and/or subcomponents of the system.

The rules engine may be used to in the classification of behaviors into patterns of behavior, or behaviors and/or patterns of behavior as fitting and/or triggering a particular trigger.

In some embodiments, a rules program may be provided for generating and storing electronic rules defining track-able parameters representative of behaviors to be incentivized and behaviors to be penalized, the parameters being based on at least one of age, region/jurisdiction, time zone, and community standards.

The parameters may be stored as electronic representations, and may also be used in various logical relationships wherein the parameters are used in determining and/or classifying behavior.

### Behaviors

In some embodiments, the system may be configured to prevent such behaviors as, for example, unauthorized spending; usage during unauthorized times of day; usage in a particular location; and/or usage after an elapsed period of time has been exceeded. The system may be configured to provide a flexible definition of behaviors and/or authorized/unauthorized behaviors through defining a set of one or more rules that may be utilized by the system in the definition, monitoring, and/or enforcement of the behaviors.

In some embodiments, the behaviors may further include various parameters related to applications and/or games, such as how violent a game is, how violently a player plays a game, to what extent a gamer is advancing educational objectives, how far a player has advanced in a game, etc. The management of behavior may also be applicable in the context of the ‘gamification’ of various tasks, for example, an application where simple tasks such as household chores may be ‘gamified’ to provide incentives related to behaviors that may be monitored and/or enforced by the system. Another example may include an application which allows the accrual of ‘points’ or incentives if the limited time or money is spent in a rationed manner over the duration of the limit interval.

Further, various behaviors may also trigger changes in rules; for example, a rule may be programmed to dynamically change itself upon the achievement/non-achievement of various goals, e.g. a rule that becomes more strict as other rules are breached, or vice versa. For example, an application may be configured to have a progressive limit such that if the limited time or money is spent in a rationed manner over the duration of the limit interval, the existing limit on the account is raised to a higher increment.

In some embodiments, system may be configured to conduct various analytical functions related to behaviors, including the ability to conduct discovery and/or learning of new behaviors and/or tweaking of rules as it relates to specific patterns of behavior. For example, the system may be able to track activity that a user is undertaking related to an application and as the activity is related, be able to classify that activity as a particular behavior or related to a particular pattern of behavior. An application may be updated from time to time, and electronic indicia of new behaviors may be provided through the update or in some embodiments, the system may be configured to identify these new behaviors through tracked aspects of interaction between the user and the application.

### Notifications

In some embodiments, the system may be configured to provide notifications through various means to various individuals. These notifications may be, for example, provided through an application, through an operating system, through the short messaging system (SMS), through a tweet, through the multimedia messaging system (MMS), through Apple's iMessage platform, through various other instant messaging applications (e.g. WhatsApp, QQ, Kakaotalk, WeChat), through any social media platform (e.g. Facebook, Twitter, MySpace, LinkedIn), through various calendaring means, through various application programmable interfaces, etc.

In some embodiments, the system may be configured to manage behavior by allowing or scheduling local and push notifications only during authorized time periods to reduce distractions.

These notifications may be subject to and/or driven by a set of rules, which may be configured to trigger notifications depending on the logic programmed within the rules.

### Rewards & Penalties

In some embodiments, the system may be configured to generate and/or provide rewards. These rewards could be used as, for example, an incentive for good performance, model behavior, or meeting an objective. Conversely the system could be used to revoke or reduce authorized spending, time, or time of usage as a penalty for poor performance, negative behavior, or unmet objectives.

These rewards may take various forms, and may include, but are not limited to, time or monetary rewards, virtual currencies, notifications to an administrative user, or various elements as may be defined within a set of rules.

### User Environment

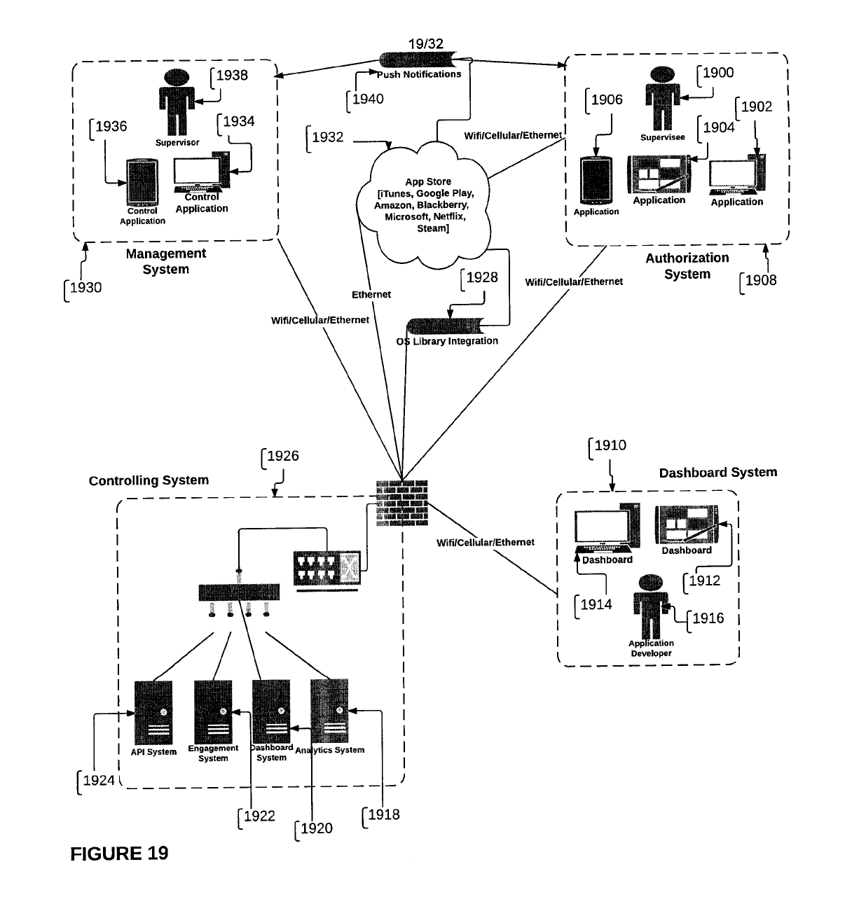

The system may operate in an environment, as referenced in FIG. 19, where one or more users, “supervisors” 1938, may have defined and/or applied a set of one or more rules to manage the behavior of one or more users, “supervisees” 1900. The supervisors may include, for example, parents, guardians, educators, daycare attendants, special need care workers, employers, patients, among others.

The system may operate in an environment where supervisees may have limited authorization to engage in activities (such as spending) within applications. The supervisees may include, for example, children, individuals using another person's account, individuals requiring supervision, novice users who may not be accustomed to online purchasing, employees using an employer's account, healthcare institutions, and/or individuals wishing to self-impose budgetary limits, among others.

The system may operate in an environment where supervisees may have limited authorization to use an application during a time of day. The supervisees may include, for example, children, students during school hours, employees during work time, individuals wishing to self-impose blackout periods, among others. The system may be potentially helpful for the enforcement of good sleeping behaviors, reducing distractions, etc.

The system may operate in an environment where supervisees may have limited authorization to use an application after an authorized duration of usage may have been exceeded. The supervisees may include, for example, children, employees, and/or individuals wishing to self-impose time limits, among others.

The system may operate in an environment where supervisees may be rewarded in various ways, such as authorizing additional time or money. The supervisees may include, for example, children incentivized for performing chores, students achieving high test scores, employees meeting performance objectives, individuals with self-imposed limits for meeting personal goals, among others. Incentives may be provided in various other ways, in various other situations, and may be set out in one or more rules.

The system may operate in an environment where supervisees may be penalized in various ways (such as by revoking authorization of time or money). The supervisees may include, for example, children behaving poorly, students with low test scores, employees failing to meet performance objectives, individuals with self-imposed limits for missing personal goals, among others.

The system may operate in various locations—for example, the system may be configured to, in conjunction with various sensors on one or more devices, identify the particular location of a particular action, transaction, device, etc., which may be utilized in the definition/monitoring/enforcement of the one or more rules.

For example, this location may be determined by various technologies, such as WiFi locating, global positioning system (GPS), cellular triangulation, etc., or simply provided manually by an individual. In some embodiments, various locations may be grouped and/or defined by the system, e.g. this area would be considered a home city, a home, an office, a school, etc.

The system may operate in an environment, as referenced in FIG. 19, where one or more users, “application developers” 1916, may have the ability to add, remove, modify, and/or manage applications within the system, view aggregate usage data, send notifications, engage with users, etc. In some embodiments, the application developers may be supervisors, supervisees, etc.

In some embodiments, the system includes at least one processor and at least one non-transitory computer-readable media, and the computer-implemented system resides on a computing device associated with the at least one user and the computer-implemented system.

The system may include various components, that may be implemented using various combinations of modules described in this specification, including a limit monitoring unit configured for tracking at least one virtual currency limit for the at least one user, each of the at least one virtual currency limit corresponding to each of the at least one user; a rules engine for applying electronic rules defining track-able characteristics representative of behaviors to be incentivized and behaviors to be penalized; a behavior tracking unit configured for tracking the behaviors of the at least one user, wherein the behaviors include at least one of physical location of the computing device, power state of the computing device, most recent activity of the at least one user on the computing device, data communications usage of the computing device, and usage times of the computing devices; and a control unit configured for controlling the usage of the computing device by the at least one user by controlling at least one of the power state of the computing device, operation of the one or more electronic applications, and transactional activity on the one or more electronic applications; wherein the rules engine is configured to periodically apply the electronic rules based at least on tracked behaviors of a user tracked by the behavior tracking unit and to periodically modify the virtual currency limit for the user; and wherein upon a breach of the virtual currency limit for the user, the control unit is configured for terminating at least one of a pending transaction, the operation of the one or more electronic applications, and the power state of the computing device.

In some embodiments, the system is not resident on user computing devices but is rather provided as a backend system configured to communicate with user computing devices. For example, a cloud and/or distributed networking system may be utilized, or a centralized server/group of servers, such as those in a data center. This type of system may be configured to interoperate with a large number of disparate computing devices.

The various systems may be suitably configured to perform various methods, including, but not limited to,
receiving a set of electronic instructions defining (i) one or more virtual currency limits defining constraints or permissions related to the operation of the one or more electronic applications, each virtual currency limit associated with each of the at least one user, and (ii) a set of triggers based on least one of patterns of positive gaming behavior to incentivize and patterns of negative gaming behavior to penalize;
periodically receiving, at a computing device, electronic indicia of activities performed by the at least one user associated with the one or more electronic applications;
determining, by the computing device, whether the electronic indicia of activities performed by the at least one user correspond to patterns of activity which trigger at least one of the set of triggers;
modifying the one or more virtual currency limits based at least in part in the determination that at least one of the set of triggers has been triggered;
wherein modifying the one or more virtual currency limits includes (i) increasing a virtual currency limit if the trigger triggered is associated with at least one of the patterns of behavior to incentivize, or (ii) decreasing a virtual currency limit if the trigger triggered is associated with at least one of the patterns of behavior to penalize.

In some embodiments, the systems may also include receiving, at the computing device, electronic information representative of patterns of activities associated with an aggregate set of other users; wherein the determining, by the computing device, whether the electronic indicia (e.g., tracking information, application-use information, transaction information) of activities performed by the at least one users correspond to patterns of activities which trigger at least one of the set of triggers includes comparing the electronic information representative of patterns of activities associated with the aggregate set of other users with the electronic indicia of activities performed by the at least one users; and wherein the set of triggers includes at least triggers based on deviations from the patterns of activities associated with the aggregate set of other users.

In some embodiments, the system may also be configured for generating one or more visual representations of patterns of activities of the one or more users compared with the electronic information representative of patterns of activities associated with the aggregate set of other users with the electronic indicia of activities performed by the at least one users; and generating one or more visual representations of a fluctuation of the one or more virtual currency limits over a period of time.

### Operating Environment

### General

The system may operate in an environment, as referenced in FIG. 19, where an application 1902 1904 1906, used as a broad term that may include games, media and entertainment applications, educational applications, etc., may be distributed through a store (virtual and/or physical) or application listing interface 1932 such as the Apple™ iTunes App Store, Google Play™ Store, Amazon App™ Store, Microsoft Windows Store™, Netflix™, etc. and the application may offer items for purchase within the application. In such systems, payment may be provided through the various interfaces, such as the platform app store interfaces. Payments may be provided in other ways as well. Platforms may offer supervisory payment approval functionality, such as, but not limited to, those featured in iOS 8™ Family Sharing. Supervisory payment approval may be automated (based on a set of rules), manual (the supervisor being able to review and/or provide approvals), etc.

In some embodiments, the system described may operate in conjunction with, or in addition to, the approval mechanisms. For example, the system may be configured to provide a first tier verification against authorized limits before a request may be sent for supervisory approval. Other types of configurations are possible, such as being used for other tiers, the sharing of logic and/or sets of rules, etc.

### Controlling System

The controlling system, as referenced in FIG. 19, may operate in a cloud-hosted 1926 or centralized hosting environment that provides, in some embodiments, web-based or mobile interfaces to monitor usage as well as provide reporting, system management, and analytics functions. This system may be also the central communications hub for the authorization 1908, management 1930, and dashboard 1910 systems. In some embodiments, the controlling system may also be provided as various applications and/or have components resident on the computing devices of one or more users.

The controlling system may act as a type of messaging hub that may also provide a repository for application logic (rules, engine, etc.), and may provide the data storage for the authorization and management systems.

The controlling system may be used to interface with a large number of different applications and/or backend systems, such that the controlling system may receive various elements of information and/or indicia of usage from these applications and/or backend systems. The controlling system may also receive information, for example, from computing devices that users may be using (e.g., through electronic communications), and in some embodiments, components of the controlling system may also be residing on these computing devices.

The controlling system may be utilized to conduct various aspects of automated and/or semi-automated control of virtual currency limits and/or virtual time limits such that the ability for a user to interact with (e.g., use, purchase, engage in transactions with, utilize features of) one or more applications may be constrained and/or facilitated.

These aspects of control related to virtual currency limits and/or virtual time limits may be provided in relation to the determination and/or detection of various behaviors and/or patterns of behavior. The control, may, for example, reward certain types of behaviors and penalize other types of behavior.

In some embodiments, the controlling system is configured such that, in combination with the analytics system 1918, the controlling system is able to dynamically conduct analyses and classifications of behaviors as positive or negative (e.g., based on a combination of rules around, violence level, where the user lives).

In some embodiments, the controlling system is configured to conduct comparisons of the user's usage as it relates to an aggregate usage of other users (e.g., other users having similar characteristics). In doing so, the controlling system may identify deviations from the aggregate usage and flag and/or automatically generate various rules that may penalize and/or incentivize deviations from an aggregate.

In some embodiments, the controlling system is configured to track various user behaviors and automatically classify new behaviors as positive or negative, for example, based on deviations from usage tracked from an aggregate of other users.

A potential advantage arising from using the controlling system is that the controlling system may provide a scalable and a configurable layer for controlling various elements of the system. For example, the controlling system may be configured for managing consistent communications (such being configured to act as a messaging bus) between various elements of the system, helping ensure that messages may be formatted properly, heterogeneous computing elements may be able to interoperate, etc.

In some embodiments, the controlling system may be able implemented to utilize cluster-computing, distributed resources, parallel computation, etc. In various scenarios, the controlling system may be helpful in managing high server loads and/or a large number of sessions.

For example, where an application may be one or more games, a healthy game engagement rate may be 30%, where approximately 8.7 million players may be active each day. Players may have 3-4 play sessions per day, the sessions possibly having an average of 3-5 minutes in duration. Each session may generate an average of 10-30 events. As a result, the daily transaction volume for one publisher may be on the order of 1.22 billion events. In situations where there are very large numbers of events/sessions/users, the efficient control and/or interoperability of the various elements may be an important consideration, for example, for operation of the system with reasonable speeds that are acceptable to users.

### Authorization System

The authorization system 1908 may be embedded within the application, through various application programming interfaces (e.g., third party APIs), or as part of the application operating system libraries 1928, and may communicate with the controlling system over a network connection. The network connection, in some embodiments, may be cellular or WiFi transports. Networks may also include wired connections, various wireless connections etc.

In some embodiments, the authorization system 1908 and/or application may also be configured to operate in a standalone manner without the presence of a network connection. For example, sets of rules may be downloaded in a synchronous or asynchronous manner, applied/monitored/enforced on the device, and in some further embodiments, upon the re-establishment of a network connection, updating accordingly and/or transmitting information accordingly. In some embodiments, the authorization system may be configured to communicate with other applications resident on the device.

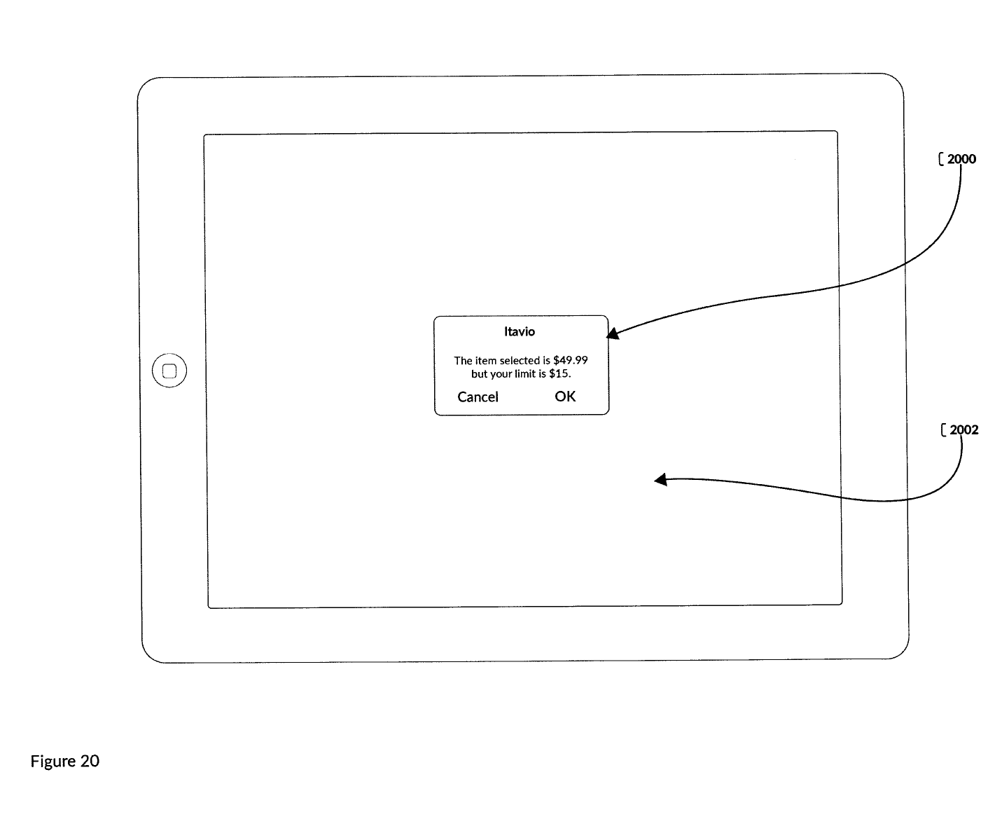

The authorization system 1908 may be configured to apply, monitor and/or enforce the rules 2000 and managing the behaviors set by the supervisor, as referenced in FIG. 20. It may be also responsible for collecting the data later fed to the analytics processor allowing reports to be viewed in the dashboard and management systems.

### Management System

The management system 1930, in some embodiments, may be a separate application 1936 1934, part of the application operating system libraries 1928, web portal, or application store system 1932 and will communicate with the controlling system over a network connection. The network connection, in some embodiments, will be cellular, wired (e.g., cabled), or WiFi transports.

In some embodiments, the management system 1930 may also be a distributed networking application, such as a cloud-networking implementation, where shared resources may be utilized in a virtualized manner. The management system 1930 may also be provided in a software as a service type implementation.

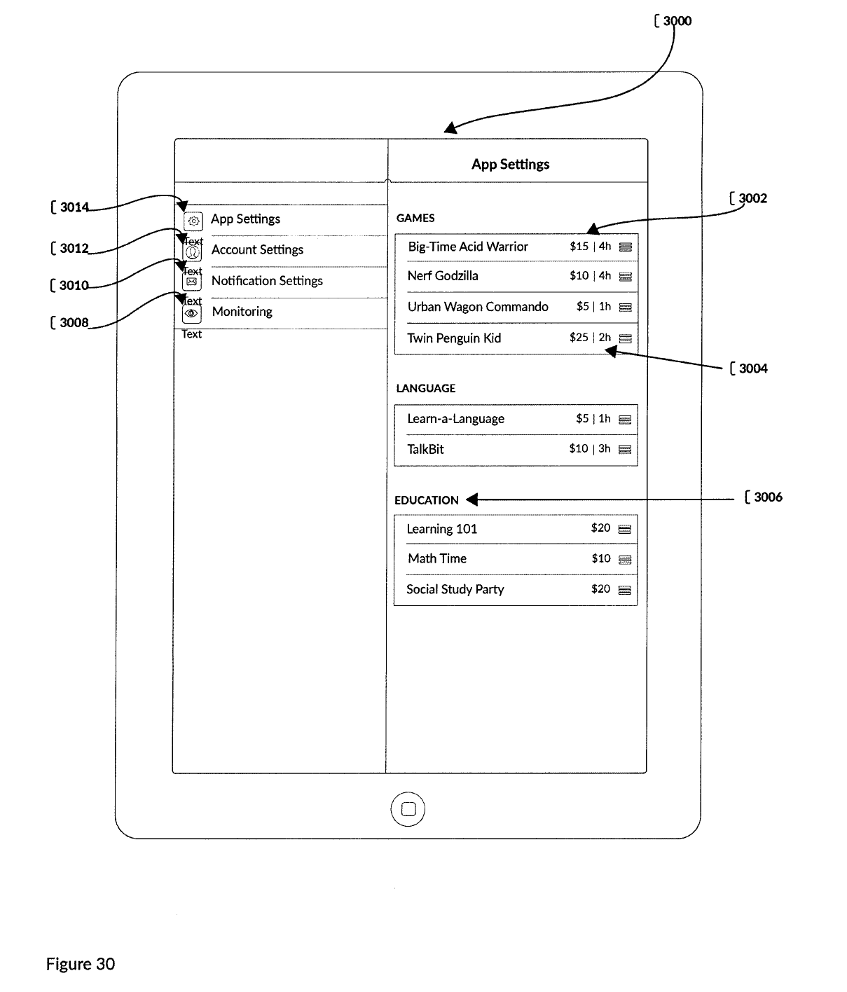

The management system 1930, as referenced in FIG. 30, may be configured to provide the supervisor with the ability to view reports 3008 of behavior patterns collected by the authorization system. The management system 1930 may also be configured to enable the supervisor to set one or more rules, such as monetary 3002 and time limits 3004, which may be applied/monitored/enforced by the authorization system 1908. These rules can also be applied to application categories 3006 to offer more or less restrictive usage (e.g. games versus educational applications). These behavior patterns and reports may also be generated as a comparative tool with aggregate usage, metrics and/or usage guidelines, which may be provided from external sources.

For example, a particular user may be compared against other users of a same or similar, living in a same or similar jurisdiction, having a same gender, etc.

The rules and/or the management system 1930 may also be used to reward the supervisee by temporarily increasing monetary or time limits. The same features may allow the supervisor to penalize the supervisee through the application of more restrictive rules. In some embodiments, the system may be configured to provide this functionality remotely without having to physically interact with the supervisee's device.

In some embodiments, the system may be configured to notify the supervisee of the change, and in other embodiments, the system may be configured such that a supervisee is not notified and/or not made aware of the changes.

### Dashboard System

The dashboard system 1910, in some embodiments, may be a separate application 1912 1914 or web portal 1920 and may communicate with the controlling system over a network connection. The network connection, in some embodiments, may be cellular, wired (e.g., cabled), and/or WiFi transports. In some embodiments, the network connection may be a wired connection. The dashboard system 1910 may be provided as part of a distributed networking implementation, such as a cloud implementation, and/or operated as a software as a service implementation, according to some embodiments.

The dashboard system 1910 may be configured to enable application developers to configure their applications to allow access through an API processor. It may also be configured to allow the application developers to view and report on aggregate behavior patterns, time, and monetary usage. The system may also allow the scheduling and delivery of push notifications 1940 and in-app messaging to be delivered in conjunction with rules defined by the supervisor in the management system.

In some embodiments, the dashboard system 1910 may be configured to provide various parameters and/or reporting so that application developers may be able to view impact, how well rules are being enforced, compliance rate, etc., so that application developers may adjust one or more rules accordingly.

For example, application developers may be able to adjust ranges of times for when applications may be usable by one or more users and view the impact the change may have on the aggregate behaviors of the one or more users. The ability to view impact and adjust parameters may be particularly advantageous in a mental health setting, where application developers may be interested in being able to tailor specific behaviors and/or applications/games closely as the user progresses through a course of treatment.

### System Flows

### Account Creation

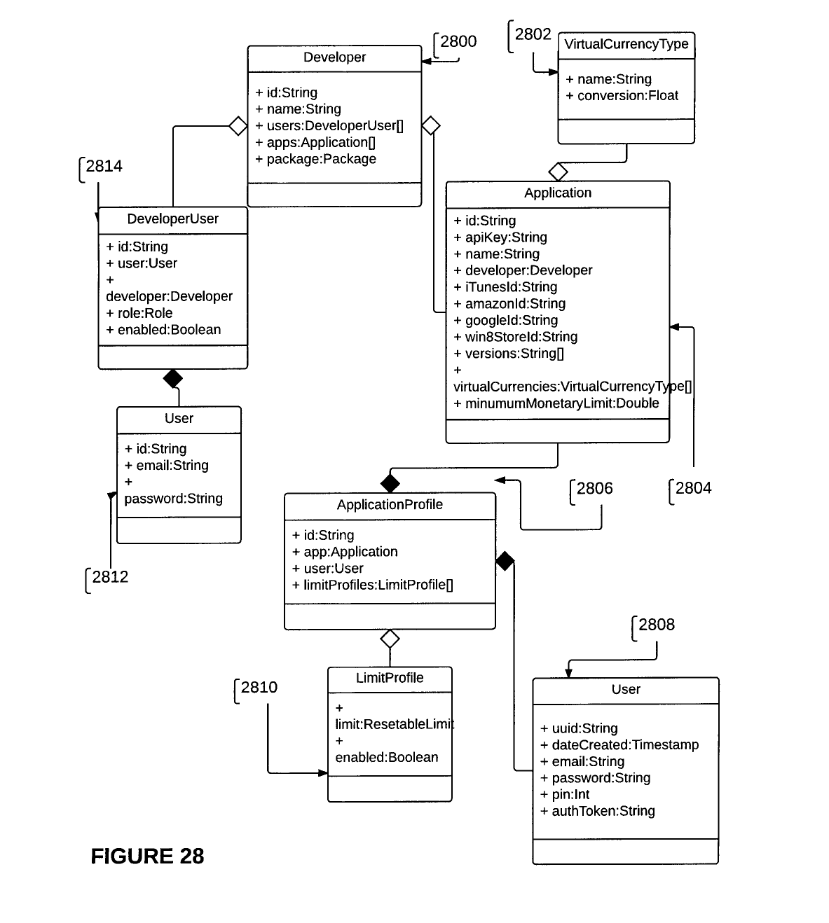

To create a system account, as referenced in FIG. 28, a user may need to supply an identifier and/or email address 2808 used for authentication and/or a password 2808 in the case that a username/email based logon protocol may be used. In some embodiments, where OpenID or OAuth protocols may be used, the system may be configured to communicate with the primary identity system to capture contact information and an authentication token 2808 for the user. In some embodiments, various other authentication techniques may be utilized, for example, and not limited to, two-factor authentication, tokens, Captchas, etc.

To create an account, the user, through the Mobile Monitoring Application, mobile application, web interface, or an embedded user interface within the application, enters their name, email and password. The API Client validates that the data is well formed, encapsulates the data (e.g., packs it) according it to the protocol transport, e.g., JSON, XML, Protobuf, binary representation, then transmits the data over the network to an account endpoint of the API Protocol Processor. The API Protocol Processor unpacks the data, validates that it is well formed, and then sends the data to the Account Manager either through an internal method invocation or calling a remote procedure over a network. The Account Manager queries the database or file system using the email address as a key to determine if the account already exists. If the account does not exist then the Account Manager converts the password to a hashed representation using a one-way hash algorithm. A unique identifier for the account is generated using a sequential long integer or a UUID (Universally Unique Identifier) and the data is stored in a database or file using methods contained within the database driver, database connection interface, or operating system IO calls. A record is created for the account and another record is created for the email address to reference the unique identifier in the account to help with subsequent database queries.

To facilitate authentication mechanisms, the Account Manager may work in concert with the Authentication Manager to store the email address along with the hashed password in a separate in-memory cache for faster lookup. When the data is stored the Account Manager responds to the API Protocol Processor returning the newly created unique identifier. The API Protocol Processor packs a response using JSON, XML, Protobuf, etc. including the newly created identifier and transmits it back over the network to the API Client. The API Client then stores the unique identifier in persistent storage such as on the file system, embedded database, or non-volatile memory for use in subsequent calls. The API Client then responds up the chain to the Mobile Monitoring Application who then notifies the user that the account creation was successful.

In other manifestations, where the system is integrated tightly into a platform's existing API, the platform provider's identity management system may be used to store the limit and account information. This coupling of an external identity management system to a limit system may utilize various interfaces associated with the third party platform to facilitate communication. A physical presence within the same data center or network location may be potentially beneficial so the limit system may have to be packaged in an appliance to allow for easy integration.

The system may be configured to generate/create an application profile 2806 in a limits database in which limits can be associated to the user account 2808.

There may be “classification profiles” that are also maintained that help define the types of behaviors and/or rules that should be applied to a particular type of user/child. For example, there may be a class of users who are male, between the ages of 10-18, and live in Malaysia. These classification profiles, for example, may be associated with rules that indicate that negative behaviors, such as accessing gambling sites, pornography, violent sites, etc., are restricted for these individuals and may be penalized through reductions of virtual currency limits or virtual time limits. On the other hand, the classification profiles may also be associated with rules that positive behaviors, such as using a e-learning portal, may be incentivized through increases of virtual currency limits or virtual time limits.

The user may be given the option to create sub-accounts for which individual limits may be set allowing a master profile to manage “child” profiles. In this case, the system may be configured to capture additional authentication credentials to differentiate and identify the sub-accounts. In sections below describing limit setting and limit enforcement, the “user” may be synonymous with either a single user profile or in the case of sub-accounts, the “child” accounts.

The user and/or child accounts may be associated with and/or “slotted” into various classification profiles. In some embodiments, the system is configured to automatically conduct a sorting function wherein, based on rules from the rules engine, the user and/or child accounts are automatically classified based on their characteristics and/or known information. In some embodiments, the classification of these user and/or child accounts may also change over time as the characteristics change (e.g., they grow up and are no longer subject to a “high schooler” classification). Where a new user and/or child account has characteristics that are significantly different from the known classification profiles and are unable to be properly classified, the system may be configured to “discover” this account as a new profile and generate a classification profile based on the characteristics of the new account. A supervisor and/or system administrator may be permitted to configure the sensitivity of the automatic classification process and/or provide feedback such that the process may improve in relation to its future accuracy.

An example of the creation process could involve a parent with two children, after having created her user account she is presented with an interface to “add a child”. She adds the first child, enters their name, potentially picks a visual avatar, and sets a limit of $20. The parent then adds the second child following the same steps but in this case sets a limit of $10 as the second child is younger. Another option is to randomly generate a nickname for the sub-account. The interface which the user enters the sub-accounts collects the sub-account details along with the unique identifier for the primary account, packs them in a format for transport similar to the method described under Account Creation and transmits the data to the API Protocol Processor.

In some embodiments, the account for the first child and the account for the second child are automatically classified by the system and rules/limits may be applied based on this classification. Based on this example, the first and the second child may be of different classifications due to their age difference.

The API Protocol Processor sends the data to the Account Manager either through an internal method invocation or calling a remote procedure over a network. The account manager queries the database to ensure the primary account exists and if it does it then generates unique identifiers using sequential long integers or UUIDs for each of the sub-accounts. The Account Manager then inserts records for each of the sub-accounts into a database or file system store and associates the sub-accounts to the primary account using the primary account's unique identifier. In some cases, the sub-accounts may be secured with a password or numeric PIN number to facilitate authentication on the sub-accounts. The password would be hashed using a one-way hash algorithm and the PIN or hashed password would be stored along with the sub-accounts. The Account Manager would respond to the API Protocol Processor returning the sub-account unique identifiers and the API Protocol Processor

### Authentication

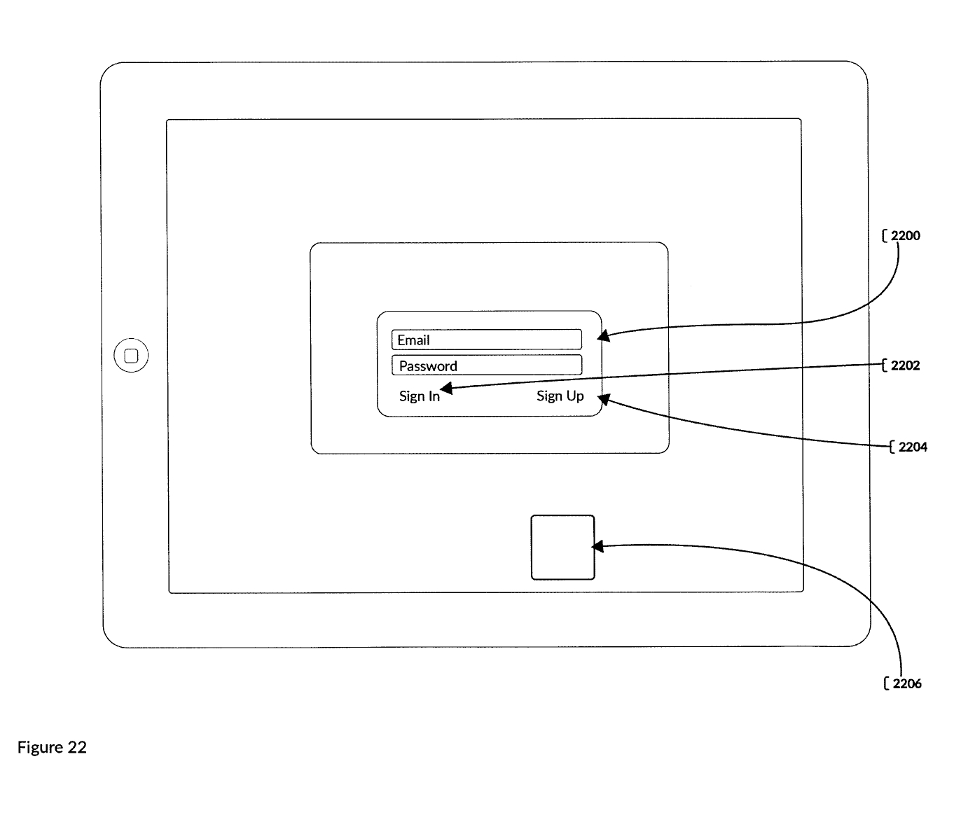

To manage limits, notification settings, or view visualizations in the application interface, mobile application, or web portal, the system may be configured such that the user 2808 or application developer 2812, 2814 may be required to authenticate before access may be granted as referenced in FIGS. 22, 28. Developers 2800 may require role-based authentication for management functions and data privacy in the dashboard application. A user's role and account status may be captured on the developer user object 2814.

An example of a role based authentication scheme could involve a developer who is granted read-only access to reports but not add new reports. An implementation would involve the developer trying to access the new report screen in a web interface, mobile application, or other user interface. Upon access, the user's authentication credentials would be sent to the API Protocol Processor, which would in turn forward to the Authentication Manager. The Authentication Manager would query the database or file system to retrieve the access rights for the user. These rights may include a list of screen names, method names, or string tokens that delineate access policies. The Authentication Manager would return these access rights to the API Protocol Processor, which would in turn return them to the user interface.

The user interface would compare the screen name, method name, or string token associated with the access being requested and compare it against the list of access rights returned from the Authentication Manager. If there are matching rights, then the user would be allowed to proceed, if not the User Interface may choose to alert the user with an error, disable access to the functionality, or hide the option to access the requested functionality.

If a username/email authentication 2200 mechanism is used, the user may provide their logon credentials along with a password 2202 that may, for example, be one-way hash encrypted before it may be transmitted over the wire. The system may then be configured to compare the logon credentials provided against the stored versions and if they are matching, then access will be granted. Various other authentication mechanisms may be possible to be used in conjunction with the system.

An example of where authentication is necessary is when a parent, using the Mobile Monitoring Application, chooses to modify the monetary limits. If a child is given access to this functionality they could inadvertently or intentionally increase their limit. To secure this process the parent is prompted for their email and password before the screen to modify the limit settings is presented. In this case the user interface would launch a dialog box or other input mechanism to capture the user's credentials.

The user interface would either match the provided credentials against credentials stored locally on the file system, embedded database, or non-volatile memory and if the credentials match would allow the user to continue with the process of modifying the limits. Another manifestation could involve the user interface sending the captured credentials to the API Protocol Processor who would in turn forward them to the Authentication Manager who would then compare against the credentials stored in a database, file system, in-memory store, or other storage mechanism. If the credentials match the Authentication Manager would return a success indicator to the API Protocol Processor who would in turn respond to the user interface with the success indicator. If the returned value indicated success then the user interface would allow the user to continue with the limit modification.

An additional manifestation could involve the user interface capturing the user's credentials and sending these as HTTP Headers or payload content along with the content of the command to modify the settings. The API Protocol Processor would first send the credentials to the Authentication Manager who would verify the supplied credentials against the credentials stored in a database, file system, in-memory, or other storage mechanism. If the credentials match the Authentication Manager would return a success indicator the API Protocol Processor who would then, if the returned value indicated success, proceed to send the command to modify the limit to the Controlling System. If the returned value indicated an invalid credential match then the API Protocol Processor would cease processing and return an error indicator to the user interface.

In the case of OpenID or OAuth implementation, the stored authentication token 2808 may be verified against the primary identity provider before access may be granted.

An example of this implementation would be for a user to choose to log into the Mobile Marketing Application using their Facebook account. Once authenticated with Facebook the controlling system could query Facebook for the user's contact information and other relevant information.

### Application Developer Integration

Application developers may be required to integrate a Client Application Programmable Interface (API) into their application. To facilitate API communication and application identification the system may generate an API key specific to each application 2804. The API key may be provided to the Client API and it may be transmitted with each call to the system. The system may also be configured to capture application developer data 2800 along with user accounts 2814 associated to the application developer to allow access to a dashboard and monitoring mobile or web application as referenced in FIG. 28. This dashboard system along with viewing data visualizations may be configured to allow the application developers to create application profiles and generate API keys.

The API key generation process would follow the account and application creation process during which the application name and platform(s) such as Google Play, iOS, Amazon, etc. are captured as well as having a unique identifier such as a long integer or UUID generated for the application. To generate the API key the system would generate both an secret key identifier and a secret key value. The secret key value is generated with a one-way hash algorithm such as SHA-256 or any other hash algorithm, which may be provided a randomly generated byte string as a seed. The secret key value is provided to the Security Manager along with the unique identifier for the application and/or any other information to be associated to the API key.

The Security Manager would then generate the secret key identifier by using a sequential long integer, UUID or random byte string and the secret key value, unique identifier, and any other supplied data would be stored in a database, file system, or other storage mechanism. To ensure another level of security the system may generate a secret key id using a one-way hash algorithm providing the application unique identifier, secret key value, and/or any other supplied information as the value to be hashed. This secret key id would be store in a similar mechanism to the aforementioned process. The secret key identifier and the secret key would be provided to the application developer who would either provide these values to the API Client Library or use them directly by providing them on any network call made to the API System. The API Client Library would take the values, potentially sign the contents using the secret key using an HMAC algorithm, and then send the accompanying secret key identifier to the API System. The API System would then try to retrieve the stored token value associated to the secret key identifier from the database, file system, or other storage mechanism using the secret key identifier as the lookup key. After having retrieved the token value the API System could then, if necessary validate the secret key id by hashing the stored contents of the token i.e.: application unique identifier, etc. and determining if the hashed value matches the secret key identifier.

The API System could then use the retrieved application unique identifier to provide as an argument any of the other services enlisted by the Client API. To prevent replay attacks wherein a previously sent message is re-used over and over a timestamp may accompany the message and form part of the HMAC signature process. The timestamp could also be used for reasonability checks to ensure the processing of the message is within a reasonable window such as minutes, hours, or days so that any data sent outside the window is rejected as being expired. The date could be used in the HMAC signing by signing with multiple keys and the date forming one of the key values guaranteeing that the signing is only valid within the day; this provides a restriction on brute force decryption attacks by limiting the brute force calculation window to be accomplished within a single day which is too short for the majority of existing hardware to decrypt. Because the operating environment may be distributed and no control or guarantee is provided for a secure and reliable connection the intrusion points that allow for manipulation are numerous.

Mobile devices allow for intercept and rewriting of network traffic and as the data being passed back and forth has financial implications a strong security model is needed to prevent tampering. Visibility and obfuscation of the data is of less importance than the integrity.

### Setting Monetary Limits

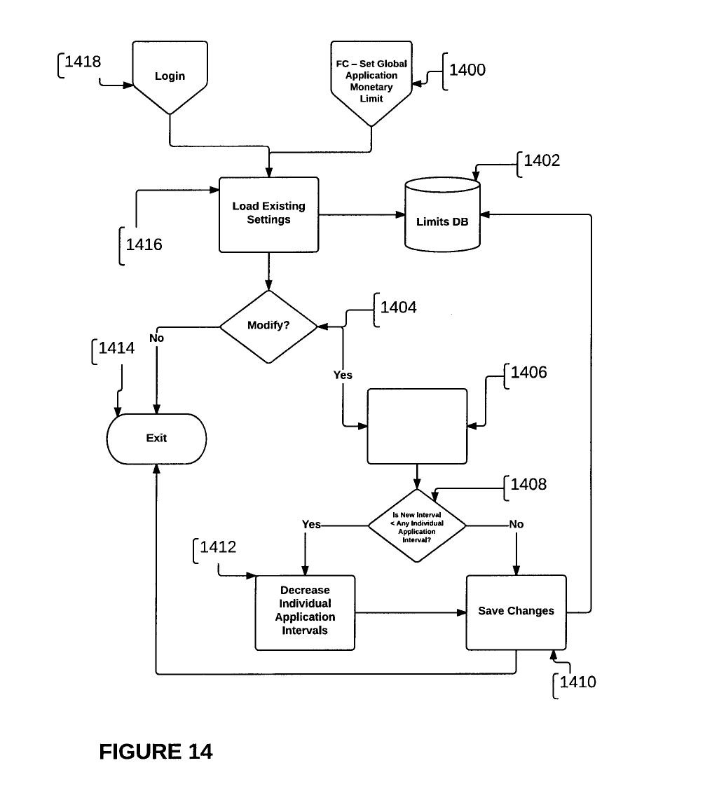

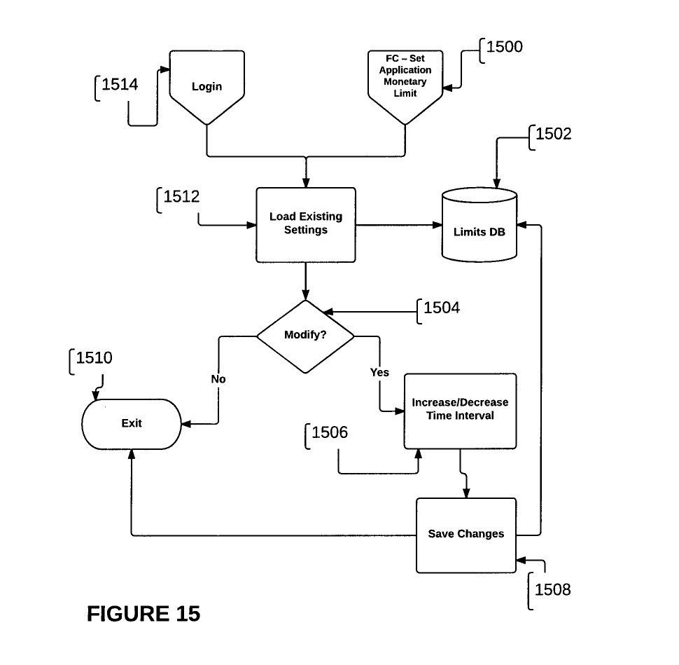

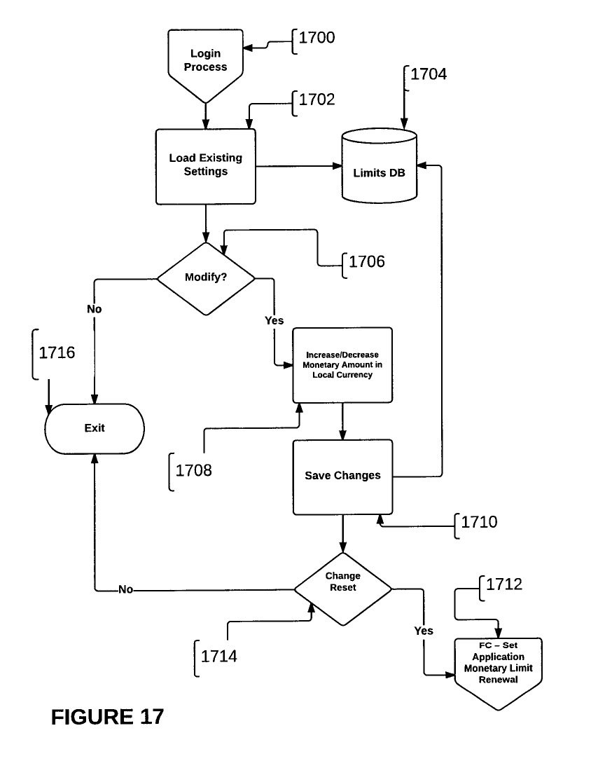

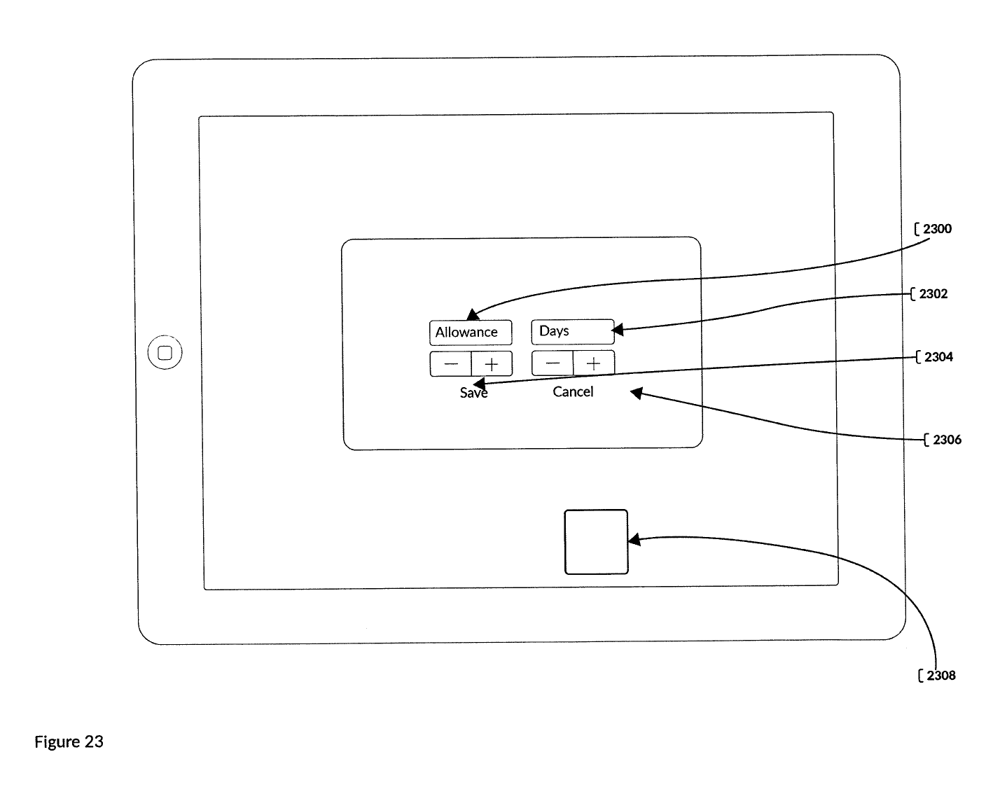

Monetary and/or time limits may be provided as a set of electronic instructions. As referenced in FIGS. 14, 15, 16, 17, and 23 a user may log into 1600 1700, the authorization system embedded within the application or external management application, and may be presented with a user interface in which they select a monetary amount 1608 1708 using a slider, number chooser, input wheel, or other input control 2300. The user may then select the renewal time period 1406 1506 which can either be a preselected time constant, selectors offering weekly, daily, monthly periods or other input control 2302 to set a numeric value in seconds, minutes, hours, days, weeks. In the case of using an external management application to manage settings, the user may be required to select the application in which the settings are to be applied.

An example of this flow could involve a parent accessing a web interface for setting limits. They would access this using their web browser and after authenticating be shown a page which has two input fields, the amount of the limit and another field giving them the choice of monthly or weekly intervals. The parent chooses to leave the limit at default setting of $5 then selects monthly as the interval. The parent then saves the changes to the settings. A manifestation of the system would involve capturing the limit monetary amount, currency code, reset interval which may take the form of a string or enumerated value, the account unique identifier as well as sub-account unique identifier if needed through a user interface. The user interface would pack this data into a format for transport such as JSON, Protobuf, Thrift, XML or other data format and send it over the network to an endpoint on the API System. The API System would then generate a unique identifier for the limit using a sequential long integer or UUID, create an additional field for limit balance, set the limit balance to the limit amount, and generate a future reset time using the reset interval as an input value.

This reset time may be stored as any of the ISO date formats or as a Unix milliseconds since epoch value. The reset time is generated by querying the system for the current time and then adding the period of time indicated in the reset interval whether it be daily, weekly, monthly or some other time period. The API System would then store a record for the supplied and generated values for the limit in a database, file system, or other storage mechanism.

The API System would also associate the limit to the account or sub-account using the account or sub-account unique identifier. After having successfully persisted the limit record the API System would return a response to the user interface indicating success and may pass back the generate unique identifier and/or other generated fields. The physical interface for the input of limits are not restricted to web or mobile interfaces but may also be embedded within a set-top box configuration and menu system, game console interface, or television controller interface.

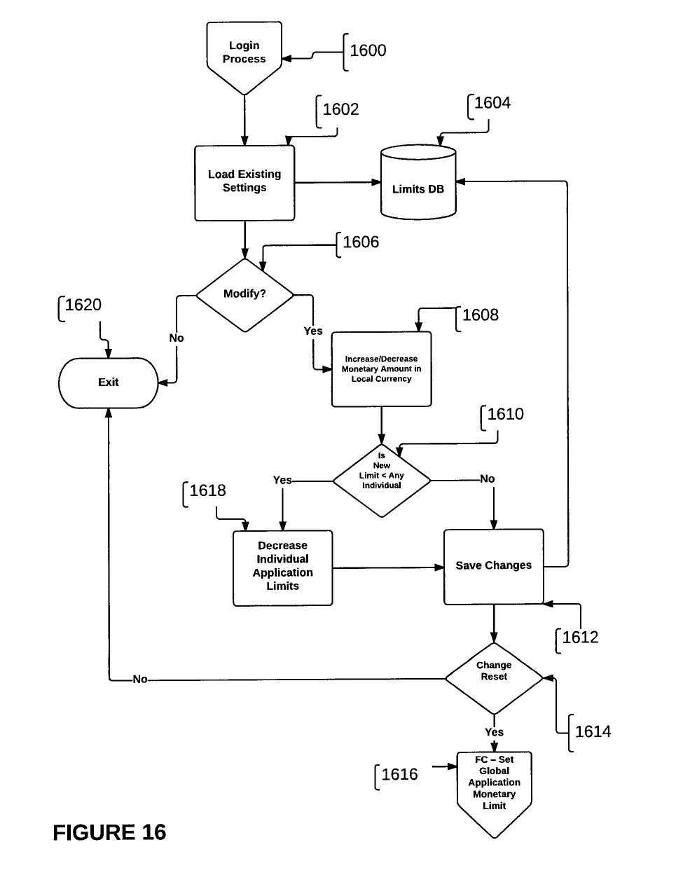

This same type of flow and interface may be utilized to set various rules, such as global monetary limits, as displayed in FIGS. 14, 16 although no application selection may be required if the system is configured to use an external management application.

This same type of flow and interface may be utilized to set a progressive limit per sub-account such that if the limited time or money is spent in a rationed manner over the duration of the limit interval, the existing limit on the sub-account is raised to a higher increment. To facilitate a progressive limit the system may allow the configuration of the progressive limit increment intervals as well as an upper limit ration and upper limit ration time interval.

For example, if the upper limit ration is $5 and the upper limit ration interval is 1 day then a sub-account spending $10 in a day would exceed the ration limit. The system may also capture an amount at which to cap the limit so that a progressive limit increase does not exceed it, such that if the current limit is $80, the increment amount is $25 and the cap being $100 then the next progressive limit increase would stay at $80 so as not to exceed the cap.

An example of this usage is for a parent to download the Mobile Monitoring Application from the iTunes AppStore™, choose an amount of $20 and a weekly allowance interval, then create their account using their email address, name and password. Upon download and install of a game by a child the game will then, in the case of an Android game, query the Content Provider interface, to determine if the parent has set limits. If the limits are discovered then any subsequent purchase attempt by the child is subjected to scrutiny by the system.

A manifestation of a system that applies progressive limits would involve, on a purchase, within the API System checking the purchase amount against the upper limit ration. If the upper limit ration is exceeded by the purchase amount then a flag within the account or sub-account could be set indicating the upper limit had been exceeded. If the amount is below then the system retrieves the amount spent within the interval, if this value does not exist then the system records the amount of purchase and the date and time of purchase. If the value does exist then the system also retrieves the progressive limit interval configuration value. If the date and time of the last purchase within the period of the current date minus the interval then the amount of last purchase is added to the amount of the currently requested purchase and if this summed amount is greater than the upper limit ration then the system will set the ration-exceeded flag.

If the summed amount is under the ration upper limit then the current date time and the summed amount is stored. This flag could be reset along with the limit reset at the next expiry time. When the limit reset interval has expired and the balance is normally reset to the limit amount the API System would check the flag and determine if the upper limit had been exceeded. If the ration has not been exceeded then the system would load increase the limit amount by the

Another example in which a parent has yet to set limits, a child may download a game and upon accessing the game's storefront, a dialog is displayed informing that the game has in-app purchases and offer the option to set limits. The child would hand the device to the parent who upon clicking to set limits, if the Mobile Monitoring Application is not installed, be taken to the device platform's app store whereby they could download the Mobile Monitoring Application. After the download and install has completed the parent could, if they have a pre-existing account, log in using their email and password credentials thereby applying the existing limit settings to the new device.

### Setting Time Limits

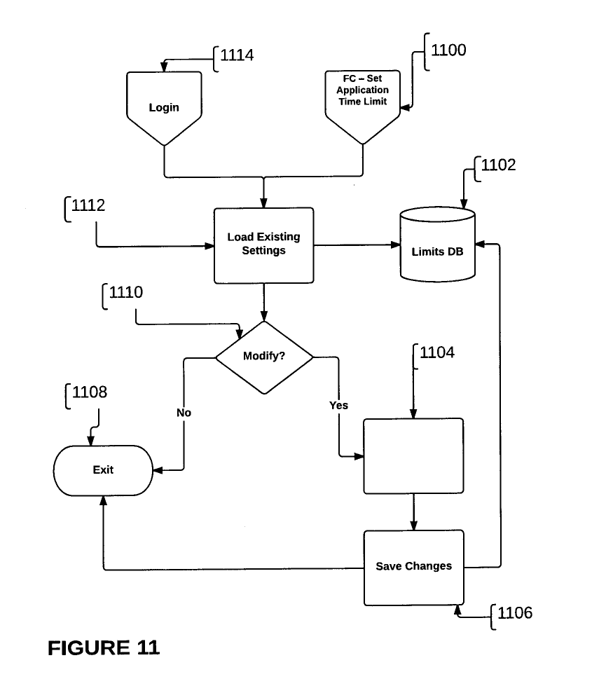

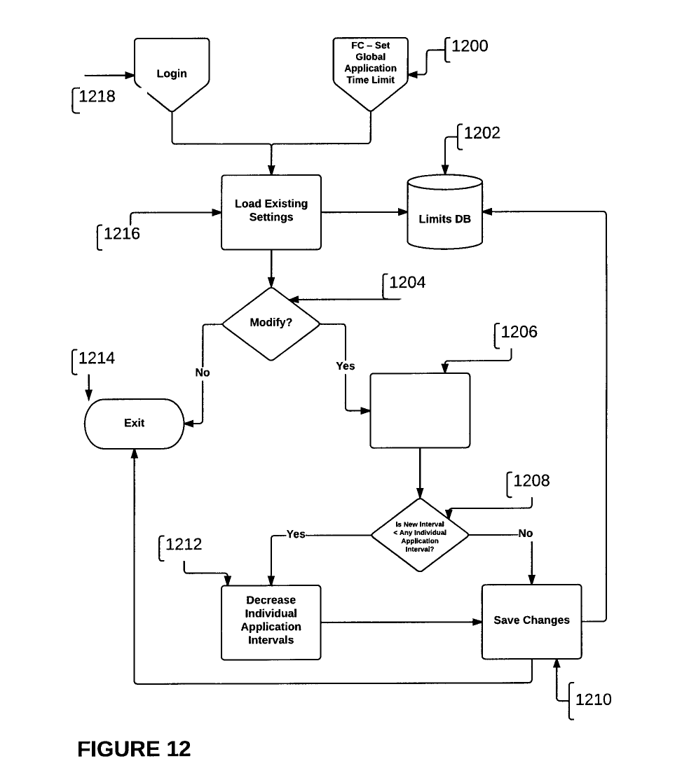

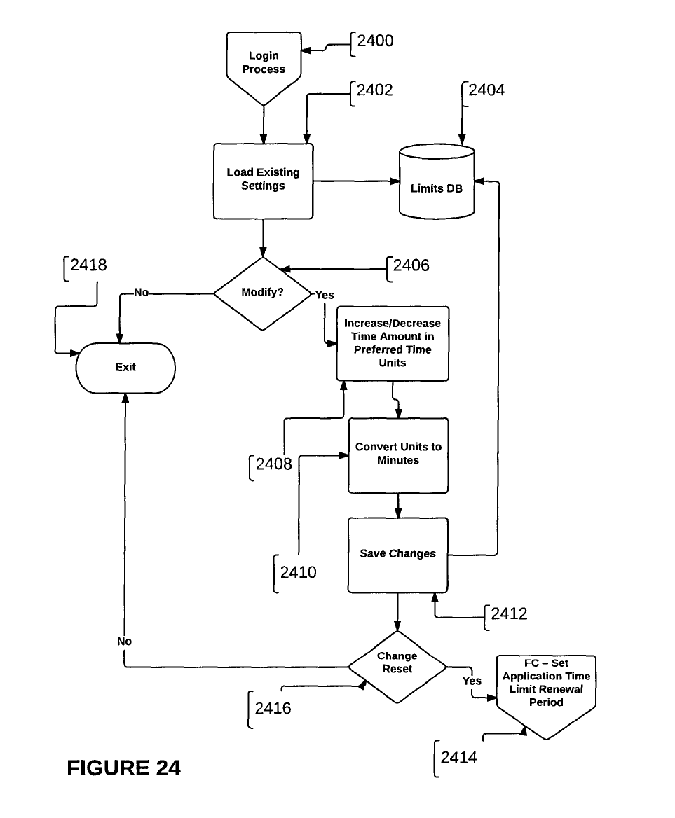

As referenced in FIGS. 11, 12, 24, 25 a user may log into the authorization system embedded within the application or external management application, and may be presented with a user interface in which they select an amount of time 2408 using a slider, number chooser, input wheel, and/or other input control. They may also choose the unit of time 2408 2508 with a radio button, checkbox, drop down, list, or other input control. The time units may include, but are not limited to, seconds, minutes, and hours. The system may be configured to convert 2410 2510, the selected units, to minutes for storage in the limits database 2404 2504. The user may then select the renewal time period 2414 2518 which can either be a preselected time constant, selectors offering weekly, daily, monthly periods or various other input control means to set a numeric value in seconds, minutes, hours, days, weeks. In the case where the system interacts with an external management application to manage settings, the user may be required to select the application in which the settings are to be applied.

A manifestation of the system would involve capturing the limit time amount, reset interval that may take the form of a string or enumerated value, the account unique identifier as well as sub-account unique identifier if needed through a user interface. The user interface would convert the time amount to a standardized base form such as minutes, hours, milliseconds, or other fractional time period then pack this data into a format for transport such as JSON, Protobuf, Thrift, XML or other data format and send it over the network to an endpoint on the API System. The API System would then generate a unique identifier for the limit using a sequential long integer or UUID, create an additional field for limit balance, set the limit balance to the limit amount, and generate a future reset time using the reset interval as an input value. This reset time may be stored as any of the ISO date formats or as a Unix milliseconds since epoch value. The reset time is generated by querying the system for the current time and then adding the period of time indicated in the reset interval whether it be daily, weekly, monthly or some other time period. The API System would then store a record for the supplied and generated values for the limit in a database, file system, or other storage mechanism. The API System would also associate the limit to the account or sub-account using the account or sub-account unique identifier. After having successfully persisted the limit record the API System would return a response to the user interface indicating success and may pass back the generate unique identifier and/or other generated fields.

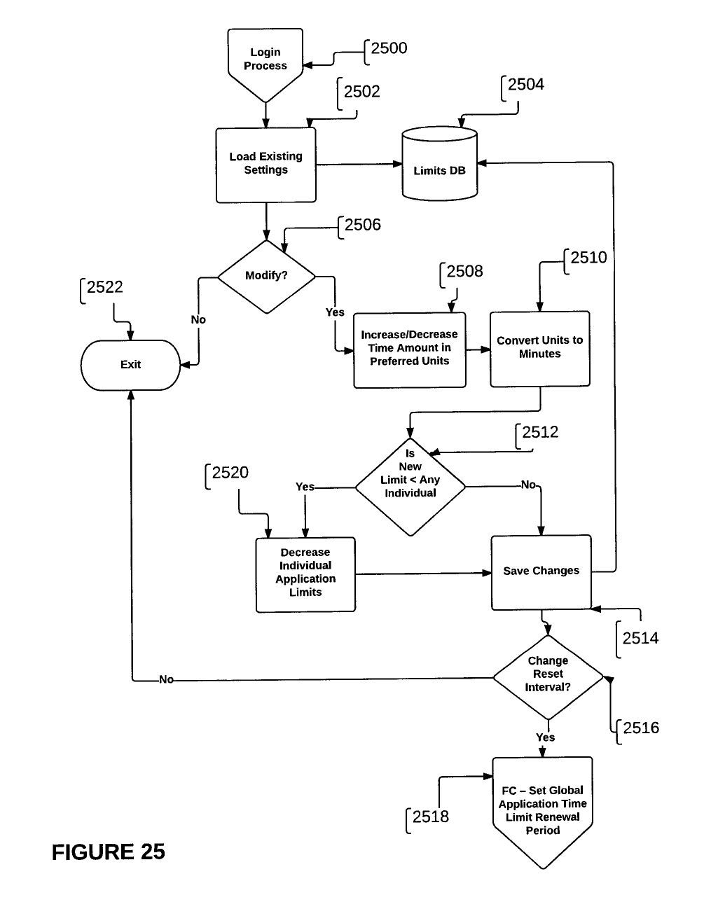

This same type of flow and interface may be utilized to set global time limits as displayed in FIG. 25, although no application selection may be required if the system is configured to use an external management application.

### Enforcing Monetary Limits

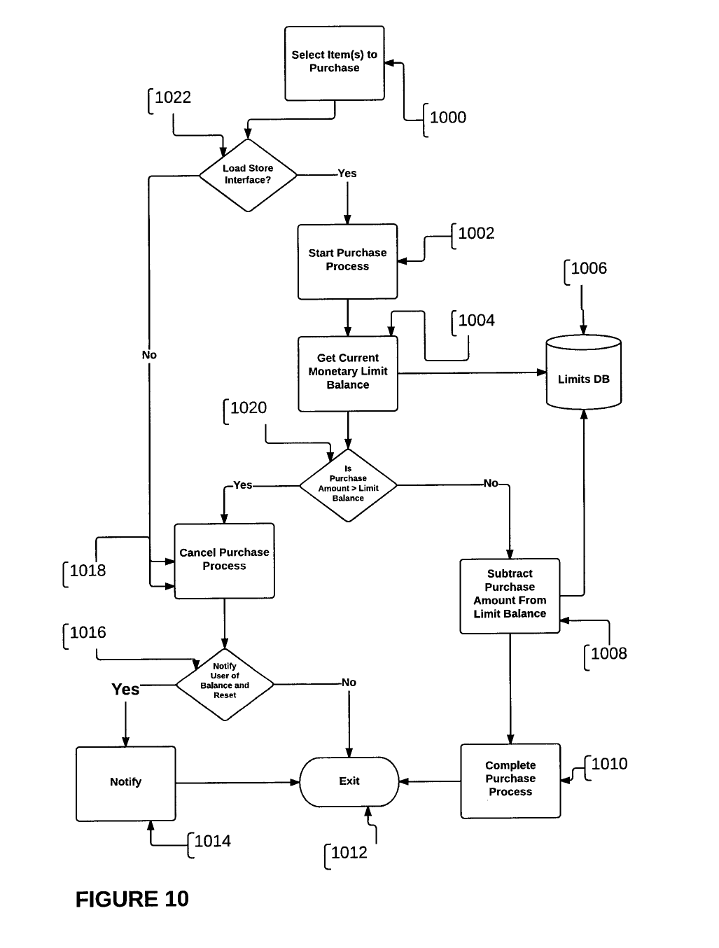

As referenced in FIG. 10, monetary limits may be enforced within the application by adding system calls in place before a user may be offered the choice to make a purchase or prior to a purchase being confirmed. The system may be configured to allow the designer implementing the application the option to either preclude loading of the store interface 1022 or to authorize it but disallow the purchase completion 1018, for example.

In some embodiments, pending transaction information may be retrieved by the system, which then may indicate that the pending transaction will cause a breach of a limit and request termination of the transaction. There may be other considerations and/or activities, such as the communication of a limit to an application (e.g., through a suitably configured interface), which then, for example, may be configured to suggest and/or alter (e.g., modify) offers such that the offers are within a limit.

A manifestation of the system would involve the application, on capture of a user's intention to purchase, call a method in the provided API Client Library to start the purchase process. This method could be provided the requested purchase amount, currency code, or in some cases the purchase amount may be standardized to a base currency such as US dollars. The application developer could then, in an asynchronous environment, register a callback function to capture the success or failure of the start purchase call. In some manifestations, the developer may make a non-synchronous call and wait for the response. This may also involve wrapping the main purchase process, involving the native app store, in an “if” block. Each device platform has divergent interfaces for implementers of store purchase process and the wrapping of each of these introduces additional complexities.

This is not limited to mobile devices but may also include game consoles, set-top boxes, television controllers or any other device that provides purchase functionality. In the case where a callback is registered the application developer would either have registered separate success and failure callbacks or a single callback return a status indicating success or failure or an error object which absence or null value is indicative of success. With these callbacks the application developer would include the method calls that access the native app store interface. In the case of a failed attempt the callback may also include calls to notify the user of the reason for failure through a modal dialog or visual indicator on screen. The API Client Library takes the supplied purchase amount and/or currency code, retrieves the account or sub-account unique identifier and API key from storage and then formats a call using JSON, XML, Protobuf, or other data format that is sent over the network to the API system. The API System, using the account or sub-account unique identifier, retrieves the associated monetary limit from the database, file system, or other storage medium.

The API System verifies that the supplied currency code matches the currency code on stored limit or in some manifestations using currency exchange rate tables converts the requested amount to the currency stored on the limit. The system then subtracts the requested purchase amount from the balance field on the stored limit. If the remainder is a positive number then the system has determined that the limit has sufficient balance to complete the purchase otherwise the system will respond indicating that insufficient funds are available. The system then generates a unique transaction identifier using a sequential long integer or UUID and stores this along with the requested purchase amount and/or currency code in a database, file system or other storage medium. The system may also generate and store a transaction status indicating the transaction has started. The system may also store the previous balance as of the time the transaction was started to verify on completion that another transaction has not modified the limit balance in the mean time. The record is stored with or referenced by the monetary limit. The API System then returns the transaction identifier if generated and an indicator of whether the purchase can proceed. The API Client Processor takes this information and if there are insufficient funds immediately returns an error code in a synchronous environment or exercises the error callback if provided, the solitary callback with error result status, or error object indicating insufficient funds. If the purchase attempt may proceed the API Protocol Processor stores the supplied transaction identifier in an embedded database, non-volatile memory, file system or other storage medium. It then either returns a value indicating success or exercises the success callback if provided or the solitary callback indicating the purchase may proceed.

The application at this point can proceed to call the native store interface and the function calls supplied within it. Upon successful completion of the purchase through the native store interface the application developer would then call the API Client to complete the purchase transaction. The API Client library would then take the stored transaction identifier and format a call over the network to the API System requesting completion of the purchase. The system would query the database, file system, or other storage medium using the transaction identifier or account identifier and retrieve the transaction and monetary limit records. In the case that the previous balance was stored the system would compare the current monetary limit balance and the previous balance to ensure they are equal. If they were not equal the system would return an error indicating that another transaction modified the limit balance in the interim. In a physical environment where a user may have multiple devices of the same or different platform the ability to prevent concurrent purchase attempts adds additional complexity due to mobile network latencies, in this environment it becomes necessary to effect some sort of transactional control or locking. If the values are equal then the system would decrement the limit balance by the requested purchase amount and if supplied, update the transaction status to complete and then persist these changes to the database, file system, or other storage medium. The API System may also generate an additional record using the account or sub-account identifier, API key or application identifier and record the purchase amount, timestamp, application details, and any other relevant or available information and store this record in a database, file system, or other storage medium.

This record may be used for reporting or visualization purposes. The API System would then format a response to the API Client indicating success or failure of the transaction. The API Client could, if a transaction status is used, query the API System using the transaction identifier to retrieve the transaction status and confirm that the transaction was completed successfully. It would then immediately return the response status indicating success or failure or if provided exercises the callback indicating a successful or failed transaction. The application developer at this point may then, if successful and, if the native store API provides the functionality, confirm the purchase transaction. The application developer could then provide whatever item was being purchased be it virtual currency, application levels or functionality, subscription, digital media, or other consumable or non-consumable item.

When a user selects an item for purchase 1000, the application may be configured to provide the Client API with the intended purchase amount as well as currency code wherein the Client API may transmit this information to the API Protocol Processor. The system may then be configured to return various values, such as a Boolean value determining whether the purchase may be permitted with the remaining limit balance being greater than the intended purchase amount 1020 and/or the system may return 1004 the remaining limit balance to the Client API where a similar calculation may be performed.

An example where a category specific limit is enforced would involve Sally who, downloaded a game called “Arcade Pinball” from the arcade category of the app store. At the same time Sally also downloaded an application called “Speak German in 10 Days” from the education category. While playing the “Arcade Pinball” game Sally ran out of balls and the game displayed a dialog offering 20 more balls for $9.99. Sally clicked to purchase the 20 additional balls but was rejected by the controlling system because her mother had set a $5 limit for applications in the “arcade” category. After being rejected, Sally opened the “Speak German in 10 Days” application and proceeded to complete the first 5 lesson plans. On attempting to access the 6^{th} lesson plan the application launched a dialog informing Sally that the 6^{th} through 20^{th} lesson plans are locked but could be unlocked for $14.99. Sally clicked “buy” to purchase the additional lesson plans and was successful, as her mother had set a limit of $20 for items categorized as educational.

A manifestation of the system in which these types of categorized limits are applied may involve the application starting a purchase process similar to the aforementioned example. When the call reaches the API System it retrieves the monetary limits for the account or sub-account from the database, file system, or other storage medium. The API System, using the API key and/or application identifier retrieves the application record from the database, file system, or other storage medium. From the application record the category field is accessed. The category field involves sourcing data from each device platform and their respective application store or listing interface and extracting the app category.

This may also involve standardization of platform specific categories to a standardized common representation. This may be accomplished with a mapping table and transformation process. This field may be a string, enumeration, or reference identifier format. The API System then either loops or filters through the monetary limit records and when a record containing a category field that matches the category field accessed from the application record it stops iteration. It then accesses the monetary limit in a similar fashion to the aforementioned example and verifies that the amount requested is less than the balance associated to the category. In the case that there is no category matching then, if available, a default monetary limit may be accessed. If not default monetary limit exists then the API System will reject the purchase attempt. The API System may also store a mapping of an application's category to a coarser-grained category whereby, for example, trivia and strategy categories are under a “thinking games” category, or casino and card games are under a “gambling” category.

If the purchase is permitted, then the application may authorize the user to proceed with the purchase. On completion of purchase, the application may inform the Client API of completion including again the purchase amount and currency code wherein the Client API may transmit this data to the API Protocol Processor. The system may debit the amount from the monetary limit balance 1008 and return an acknowledgement of success to the Client API. On receipt of acknowledgement the application may confirm and complete the purchase transaction 1010.

An implementation could involve a successful purchase of a $5 item in game. The player previously had a balance of $20. After successful completion of the transaction the system will have a recorded remaining balance of $15.

If the purchase is not permitted, then the application developer may have the option of notifying 1014 the user of the reasons for the purchase being disallowed or they may be able to silently suppress the purchase attempt. The Client API may also, optionally, provide the remaining balance amount along with the date of limit balance reset 1016 to allow the application designer to use this information for marketing or purchase discount purposes.

A designer may wish to offer the intended item at a discount lower than the remaining limit balance or offer an alternative item that may be lower than the remaining limit balance.

An example of this would be if Dan, who had a weekly allowance of $10, were playing a game that had a store offering packages of gems. The price of 10 gems is listed at $0.99, 100 gems for $4.99, 1000 gems for $9.99, and 25,000 gems for $24.99. In playing the game Dan clicked on a package of 25,000 gems with intent to purchase. The system would prevent the purchase and instead of showing an error dialog to Dan the game could intercept the rejection and query the API Client libraries to determine that Dan had $8 remaining of his $10 allowance. With that knowledge the game would inform Dan that he couldn't purchase the $24.99 item offering 25,000 gems but that he could purchase 5,000 gems for $7.99. This would provide a customized offer to Dan within his purchase price range but at a significant valuation higher than the next highest price point of 1000 gems for $9.99. A manifestation of the system could involve the application starting the purchase process similar to aforementioned examples but on the failure response the API Client would then access, either stored in an embedded database, file system, or non-volatile memory a list of purchasable items. The data points contained within this may include the item price, description, image or URL to an image, product sku, application supplied product identifier, marketing text, number of units, or other supporting data. The API Client could then take the remaining balance returned by the API System, through an additional call or as part of the data points returned in the purchase rejection and loop or filter through the list of purchasable items until the subset of purchasable items with an item price lower than the remaining balance are left.

The subset of items may then be displayed in a store like interface to the user of the application or an individual item may be displayed. The display format may be accomplished using a stored template that is distributed as part of the API Client or downloaded from the API System and associated through the application identifier. In the case of display of an individual item the API Client, in some manifestations, select the item that has a purchase price lower than the remaining balance but higher than any of the other items below the remaining balance. In some manifestations the API Client may take the items with purchase prices below the remaining balance and apply a multiplier, which may be resident as part of the API Client or retrieved in a configuration over the network from the API System and associated to an application identifier. The multiplier would be used to increase the number of units from the base in the stored items listing. In some manifestations the visual representation of the store items may indicate the additional units by showing a percentage increase, the base amount with a strikethrough, or a general indicator to draw attention to the increase.

In some manifestations the API Client, upon selection of an item for purchase, may complete the purchase transaction using native app store functions. In this case the flow would also follow the aforementioned purchase examples where limits are applied. In other manifestations when an item is selected for purchase by the user the API Client would call a function supplied by the application or expose an event that contains the item sku, application specific product identifier, price, number of units, or any other required or optional information so that the application can complete the purchase process as in aforementioned examples.

The visual representations may, to not break the immersive experience, be implemented by the application provider using a template system provided as part of the Client API. The templates, in some instances, may be launched in an internal browser. The template system may have a descriptive layout format using HTML, JSON, XAML, XML, or a DSL made for template purposes. The template may contain coordinates for image and text placement, path to linked image files, language resources for internationalization and other relevant template information. The template definition would necessarily have to be created external to the application and Client API to allow remote configuration. To accomplish this the API System would have an interface for the application developer to manage the template details. The API System would also store the completed templates in a database, file system, in-memory cache or other storage medium. A content distribution network may also be leveraged to provide for speedier template retrieval. The API System would provide the templates directly or URL paths to the templates for the application being used. In some embodiments, an implementation of the Client API may involve abstracting the purchase process from the application and provide payment provider library wrappers to effect finer grained control over the purchase transaction. In some embodiments of the system, possible integrations include, but may not be limited to, the Amazon™ API, Google Play™ API, Apple's iOS™ API, Apple's Mac™ API, Microsoft Windows Store™ API, Microsoft Windows Phone™ API, Blackberry™ API, Paypal™ API.

The toolset may then wrap purchase transaction calls to the native platform APIs while potentially reducing the application developer's need to make function calls to the API Client Library and payment provider API.

An example implementation could provide the application developer with an API that has a single method to “purchase”. The provided API would determine if the user had limits and if so would contact the controlling system to determine if the user had sufficient balance. If the user has sufficient balance the API would then initiate a call using the native platform's app store programming interface. If the purchase was successful then the API would confirm the purchase with the native app store and if confirmed then make a call to the controlling system to register the transaction as complete. The API would then return control to the calling application returning a status indicating a successful purchase.

The purchase transaction may be initiated, confirmed, and completed within the Client API abstraction.

In some embodiments, the system may be configured to integrate the monetary limitations within the app store itself, thereby potentially allowing the app store to reject purchase attempts after contacting the controlling system. In some of these embodiments, there may be no need for a specific API implementation within the application; the implementation may be provided through the application store services.

An example of this type of integration solution would be if Steve, using his Kindle, tried to purchase a book for $15. During the purchase validation process in which the Amazon payment portal verifies the payment method calls would be made to the controlling system to determine how much allowance Steve had remaining. The controlling system would notify Amazon that Steve had sufficient balance and Amazon would continue with the purchase process. Upon completion of the purchase Amazon would notify the controlling system, which would decrement Steve's remaining balance by $15. A manifestation of this type of system could involve the app store application, either resident in the device making the purchase, or in other manifestations, on the central system that all devices connect to, assembling a command using JSON, XML, Protobuf, or any other binary or text based messaging format that includes the account or sub-account identifier, requested purchase amount, currency code, or amount standardized to a base currency such as US dollars over a network to the API System. The calls to the API System could be facilitated with the supply of an API Client library or implemented wholly by the app store using network calls and message format definitions. The API System would process and validate the purchase request in the manner described in aforementioned examples. The user accounts, in the case of a direct app store integration, may involve an export of user accounts which, at a minimum, include an identifier that would be sent over a network or other offline medium to the API System. The app store may, in some manifestations, provide the user interface in which the details of the monetary limits are captured and associated to the user accounts. This information would be sent to the API System over a network connection using defined message formats in a manner similar to aforementioned examples.

### Enforcing Time Limits

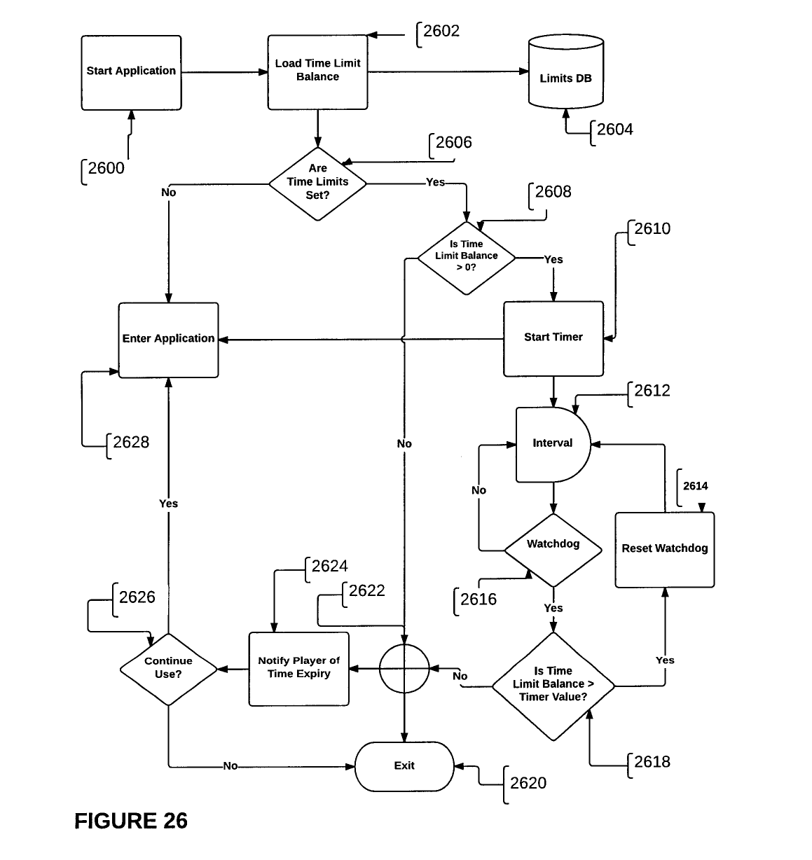

As referenced in FIG. 26, time limits may be enforced within the application by recording elapsed usage session time within a single application and/or across applications associated to the account. The recording and/or enforcement of time limits may be accomplished by making function calls to the Client API indicating at least one of the starts of a usage session as well as the end of the usage session, among others. Internally, the Client API may use a timer 2610 to record the elapsed playtime. At the end of a usage session, or on interruption or on commencement of new usage session, this elapsed time may be transmitted to the API Protocol Processor where it may be recorded and deducted from the remaining time balance for the application or across applications. The time limits may be inclusionary (e.g., the user is encouraged to use the device between certain periods of time), and/or exclusionary (e.g., the user is encouraged not to use the device outside of certain periods of time).

A manifestation of the application implementing the Client API would, on initialization, using a hook provided by the operating system services, instantiate the Client API. On instantiation the Client API would format a call, over the network, to the API System and retrieve the elapsed session time as well as the time limit amount. The Client API would also start an internal numeric timer starting at zero. The operating system services could be used to provide timer functionality as well as threading, scheduling, or interrupt functionality. The Client API would schedule a periodic job, the interval set to a small enough value to be under a normal application session length but not so small as to affect system performance (ideal timing would be within a 500-5000 millisecond range), that will execute a method that takes the elapsed session time retrieved from the API System and adds it to the internal timer. If the sum is greater than the limit value then the API Client can, in some cases format a message to the API System notifying of timer expiry. In other manifestations the API Client could initiate a message to the application user through the platform provided notification scheme or using user interface elements such as dialog boxes. A further manifestation would involve sending an event or making a callback into the application notifying of expiry and allowing the application the ability at that point to gracefully close the application session. In other manifestations the Client API on expiry could terminate the application in which it is embedded. If, during the application session, the timer plus elapsed session timer never exceeds the limit value then at the end of the application session as defined as the closing of the application, passivation, loss of focus, or other recognized session ending events, the Client API will format a message that is sent over the network to the API System containing any necessary unique identifiers as well as normal session time information such as start and end times and it may also contain the elapsed session time calculated by the timer. This is sent to the API System where it adds the elapsed session time to the current elapsed session time for that period. It then stores the value in a database, file system, in-memory store or other storage medium. This mechanism also works when the device does not currently have a cellular connection. Event data that is reporting in nature may be stored locally until the Client API detects a network connection and is able to flush the data.

Another manifestation of the system that tracks and enforces time limits could involve the Client API would, on initialization, using a hook provided by the operating system services, instantiate the Client API. On instantiation the Client API would format a call, over the network, to the API System to indicate a session has started. The API System would start an internal timer at zero and retrieve the elapsed session time for the period from a database, file system, in-memory store or other storage medium. It would also store the current date time in the database, file system, in-memory store or other storage medium. The API System would have a function that takes the elapsed session time for the period and adds the provided timer value and compares the sum against the allocated limit. If the limit has been exceeded then the function would return an indicator, such as a Boolean, to the caller. The API System would execute this function on the first start session call and return an indicator in the response to the Client API or implementation on the application side indicating whether the session may continue. The response may also contain configuration values for subsequent heartbeat messages.

The Client API or calling code in the application processes the response and determines whether the time limit has been surpassed and whether the session may continue. If it's determined the session may continue then the application starts schedules a periodic job, most likely at an interval of 5-90 seconds, that when triggered indicates that the application must send a heartbeat message to the API System. The heartbeat message, to conserve data costs, may be UDP, TCP, Websockets, HTTP, or other network protocol. It may involve transmission of a data package but normally is a lightweight structure. The message is sent over the network to the API System or in some manifestations, where there is a persistent connection, the API System may initiate and send heartbeat messages to the application in a PING/ACK pattern determining based on an ACK response that the application is still connected and involved in a session. The API System on receiving a heartbeat message would note the current date and time and then load the time of the last heartbeat event or the session start event from the storage medium. It would then subtract the date time of the last heartbeat or session start from the current date time. Applying a corrective value may also accommodate for compensation for network lag or latency. The remainder is added to the stored timer value and then that value is provided to the previously described function that evaluates whether the time limit has been exceeded. If it hasn't then the API System will record the date and time of the last heartbeat in the storage medium and will respond to the application using either an indicator or the lack of indicator as acknowledgement that the session may continue. If the timer has been exceeded then the API system may reply to the heartbeat indicating time expiry and allow the application to deal with the expiry as in aforementioned sections. If, during the session period, the time is not exceeded then the application may send an end session event on application termination or passivation, which triggers the API system to record, elapsed session time and add it to the stored value. The API System may also use the last stored heartbeat value as the end of the session value in the event no end session message is sent. The API System, on next session initialization, can look for any previously open-ended sessions and close them off before starting fresh.

On start of the usage session 2600, the Client API may be configured to return the remaining time balance available for usage 2602; if the balance is less than zero 2608 or less than a reasonable usage session length then the application designer may have the option 2622 of notifying the user and disallowing the usage or if a less intrusive approach may be used, to provide a warning to the user that their time balance is expired 2624.

An example of this type of notification could involve showing a timer in the corner display of a game that counts down the remaining time balance. The player could use this visual cue to determine when to complete the game at a savable point.

Another example could involve an application that shows a dialog box informing the user they have 5 minutes remaining before the application is forcibly closed.

During the usage session 2612, the Client API may have the option of triggering 2616 a system event or notification if the elapsed usage time has exceeded the remaining time limit balance 2618, potentially providing the application designer the ability 2622 to interrupt an in-progress usage session.

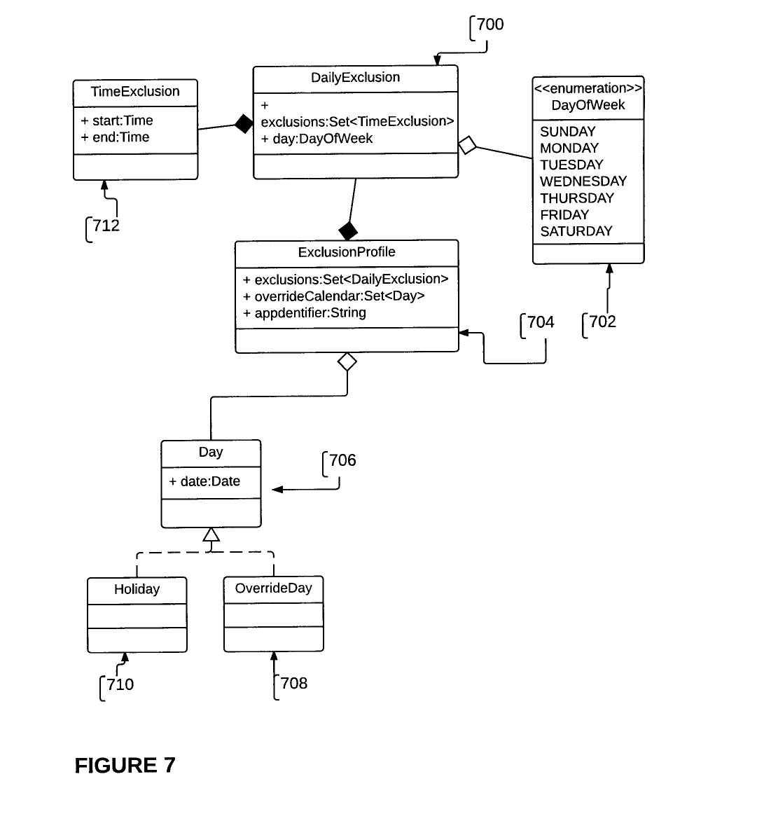

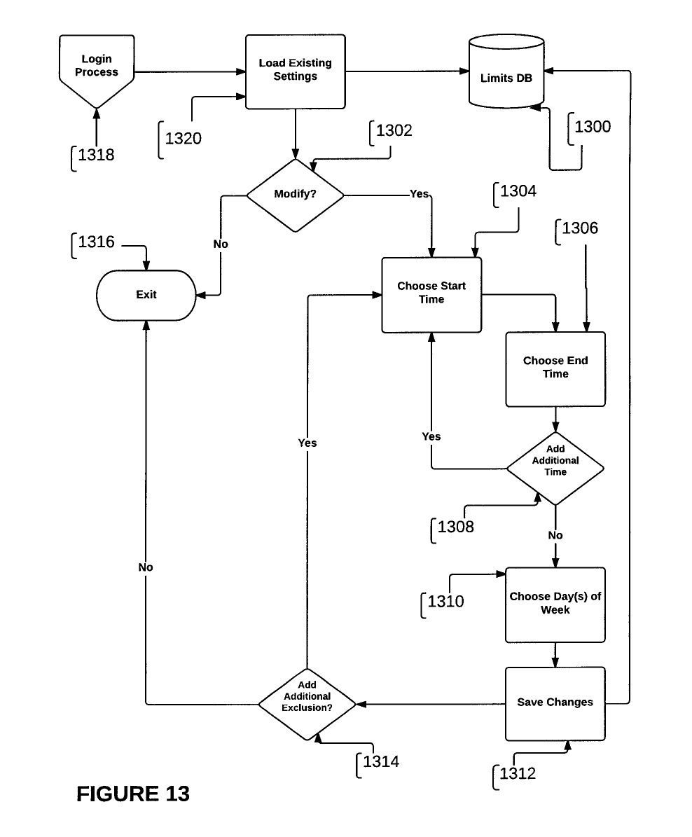

A user may set exclusionary times as referenced in FIGS. 7, 13 by defining time blocks 712 with a start time 1304 and end time 1306. There may be multiple non-overlapping time blocks 700 defined in a profile. The user then may have the ability to select which day(s) of the week 702 in which to apply the exclusionary times. The interface may also give them the ability to apply the blocks using shortcuts such as “weekdays”, “weekend”, etc. The interface may also be configured to allow the user to set rules that define override days 706 708 in which the regular exclusionary blocks do not apply. The interface may allow the user to select predefined “holidays” 710 from a standard calendar to add as override days, with the system developing rules accordingly.

An example of setting exclusionary times could involve a parent using the Mobile Monitoring Application chooses to set time limits. The parent is shown an interface that resembles a week's view of a calendar showing time increments for each day in half hour blocks. The parent clicks on the option to apply “smart defaults for school” and the interface would populate the time blocks between 8 am to 4 pm and 9 pm until 6 am for the days Monday to Friday. The parent decides they do not want their child playing until after dinner on Mondays and Tuesdays so she extends the time blocks for those two days until 5:30 pm.

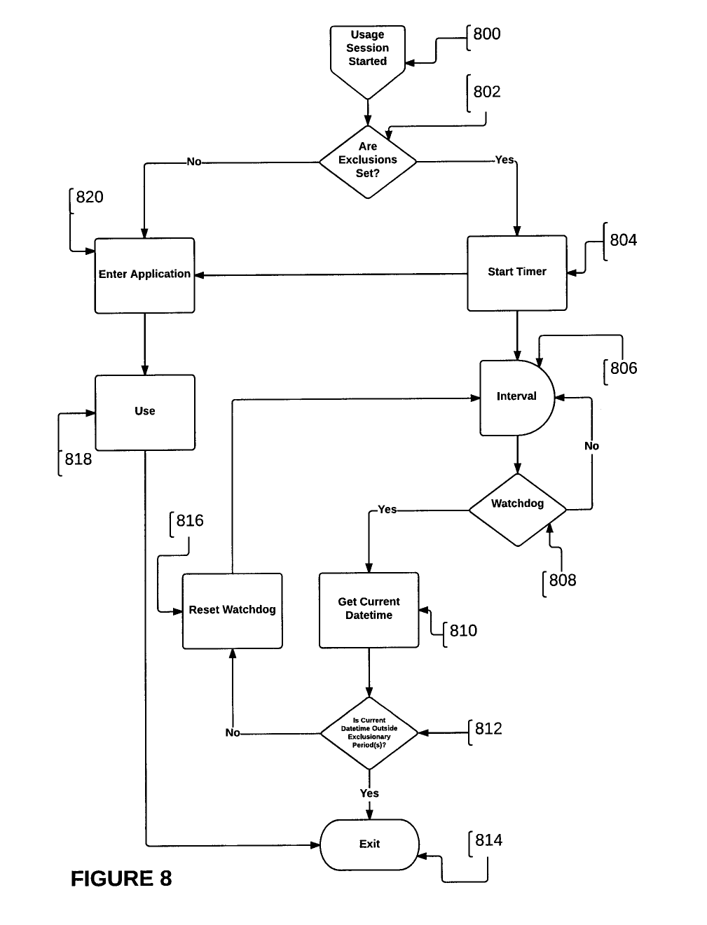

If 802 exclusionary times as referenced in FIGS. 7, 8 may be set then a list of these time blocks for the day may be returned in the startSession response. The Client API may then retrieve the current time 810 and from the network to eliminate the possibility of the user changing the device or system time. The Client API may determine whether the current time is within the exclusionary time 812 and if it is, the Client API may be configured to notify the calling code 814 so the application designer may have the option of notifying the user and disallowing the usage or if a less intrusive approach is used, to provide a warning to the user that they may be playing during exclusionary time. If usage is authorized, then a decrementing timer 804 may be set with the duration being the current time subtracted from the next exclusionary time. If the timer expires 808 during application usage, then the system may be configured to notify the calling code so that the application designer may have the option of notifying the user and disallowing the usage or if a less intrusive approach is used, to provide a warning to the user that they may be playing during exclusionary time.

A user may set inclusionary times by defining time blocks with a start time and end time. There may be multiple non-overlapping time blocks defined in a profile. Accordingly, the system may then provide the user with the ability to select which day(s) of the week in which to apply the inclusionary times. The interface may also give the user the ability to apply the blocks using shortcuts such as “weekdays”, “weekend”, etc. The interface may also allow the user to define override rules (e.g. certain days) in which the regular inclusionary blocks do not apply. In some embodiments, the interface may be configured to allow the user to select predefined “holidays” from a standard calendar to add as override days.

An example of setting this type of limit could involve an employer who provides use of tablets at work. The employer could configure an inclusionary time such that the only blocks of time in which employees could access non-work related content to lunch breaks between 12 pm to 1 pm and break times for 15-minute blocks at 10 am and 2 pm. An employee that launches an application that enforces time limits would be notified through a dialog that the application was being accessed outside the permitted hours then the application would close itself.

If inclusionary times are set, then a list of these time blocks for the day may be returned in a startSession response, for example. The Client API may then retrieve the current time and from the network to potentially reduce the possibility of the user changing the device or system time. The Client API may determine whether the current time is outside the inclusionary time and if it is, the Client API may be configured to notify the calling code so that the application designer may have the option of notifying the user and disallowing the usage or, if a less intrusive approach may be used, to provide a warning to the user that they are not playing within an inclusionary time. If usage is authorized, then a decrementing timer may be set with the duration being the current time subtracted from the end of the inclusionary time window. If the timer expires during application usage, then the timer may notify the calling code so the application designer may have the option of notifying the user and disallowing the usage or, if a less intrusive approach may be used, to provide a warning to the user that they are playing outside of an inclusionary time.

### Notifications

In some embodiments, when a user account is created and provided to the system, the system may be configured to send various communications (e.g. an email, SMS, or push notification, audio message, video message, among others) to the registered address to potentially help validate and/or reduce falsified accounts. This notification may be used to confirm account creation and to communicate with the user on an ongoing basis.

An example of a manifestation of this type of notification scheme could involve, on account creation, the system communicating with an external system such as Mailchimp, Send mail, Exchange, Postfix, or other mail list or transactional email system and sending a welcome email as well as, in some manifestations, and email containing a URL to confirm account creation. This email would be sent, using a network connection, API client, or operating system call using the email address supplied during account creation. In the case of confirmation, a token would be generated and stored in a database, file system, in-memory, or other storage medium and sent as part of the URL. When the user clicks on the URL to confirm the account the generated token would be accessed from the querystring and compared against the token stored in persistent storage. If the tokens match then the account, in some manifestations, could have a status flag changed to indicate the account has been confirmed.

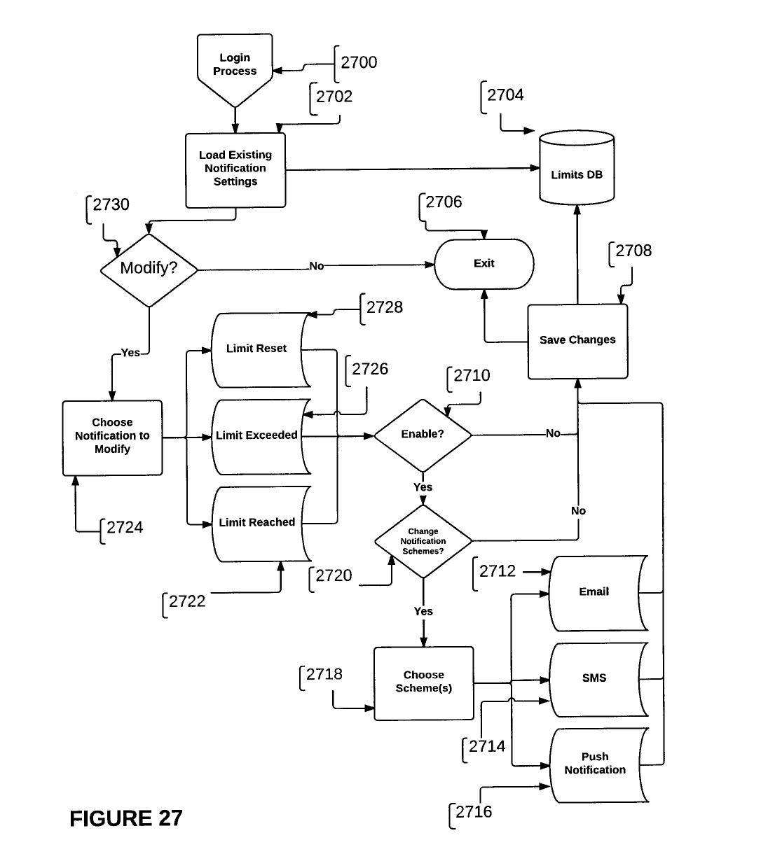

In addition to the account notifications, the system may be configured such that the user may have the option of configuring their preferences for notifications of other system events as referenced in FIG. 27. A user may have the option of choosing what mechanism, (e.g. push notifications 2716, email 2712, SMS 2714), the individual notifications 2714 to be received as well as being able to enable and disable 2710 notifications.

An example of this type of granular configuration could involve a parent who chooses not to be notified whenever their child tries to purchase anything over their limit but wants to be notified when their child is accessing games at times that are considered “exclusionary” so they can address the infraction with the child.

In some embodiments, when the monetary or time limit may have been reached, the system can be configured send out a notification to the user 2722. In some embodiments, the system may be configured to also provide notifications based on one or more sets of rules, for example, when a monetary or time limit is about to be reached, a predetermined threshold is met, etc.

In some embodiments, when the monetary or time limit may have been reset, the system can be configured to send out a notification to the user 2728.

This type of notification could be used by a game studio to improve game re-engagement and incentivize a player to come back into the game and spend their new allowance. The game could incentivize with additional content or sales.

In some embodiments, when the monetary or time limit may have been exceeded, the system can be configured to send out a notification to the user 2726.

### Rewarding or Penalizing a User

The system allows a supervisor to incentivize or penalize behaviors exhibited by the supervisee. Various behaviors are tracked, for example, and the behaviors may be classified and/or otherwise clustered such that patterns of behavior can be determined.

In some embodiments, rules from the rules engine may be utilized to determine whether a particular behavior or pattern of behavior is related to positive (e.g., beneficial) or negative (e.g., deleterious) behavior, and to reward and/or penalize the user accordingly, though, for example, increasing a virtual currency limit or a virtual time limit.

The definitions of positive and negative behavior may be flexible—e.g., for example, the positive and negative behavior may vary depending on the age of a user, where the user is located, community standards, etc.

The definitions of positive and negative behavior may also include classifications wherein, for example, based on past classifications by a supervisor, the system engages in machine learning to either recommend or automatically classify behaviors based on common characteristics that are determined over a period of time. For example, a new behavior may be tracked for a particular application that appears to be fairly violent and involve a costly transaction (in real world currency). The system may have recognized that the supervisor had instituted similar rules in the past where such a behavior was classified as negative. The system may then attribute an electronic score to the behavior, indicating how close it was to past rules that the supervisor had input. If the electronic score is greater than a particular threshold, then behavior would automatically classified as a negative behavior.

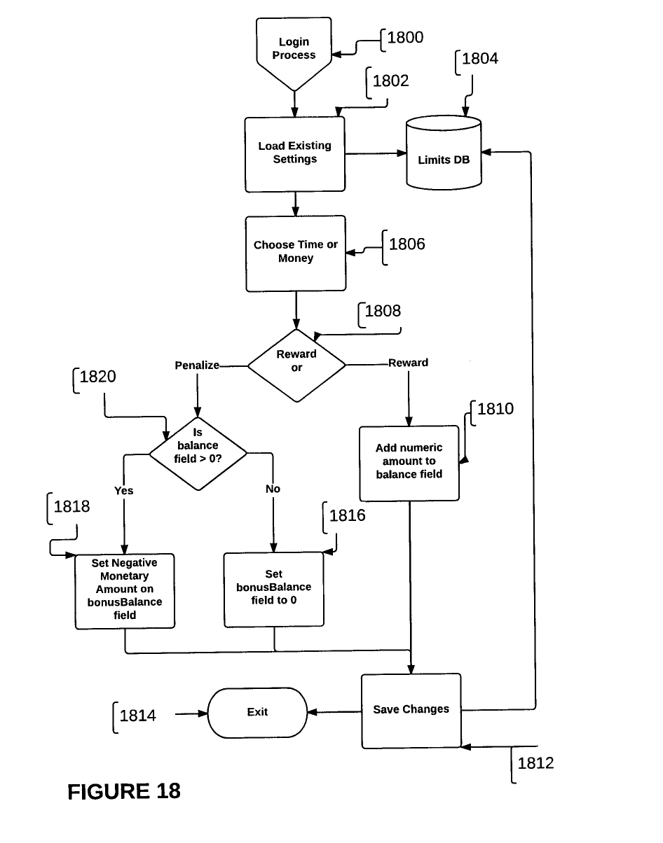

As referenced in FIG. 18 the supervisor may be able to use the management system to also manually temporarily increase or decrease 1808 the limits set on the account. In some embodiments, the system is configured such that rules applied by the rules engine cause the system to automatically increase or decrease 1808 the limits set on the account based on sensed and/or tracked behavior information and/or patterns.

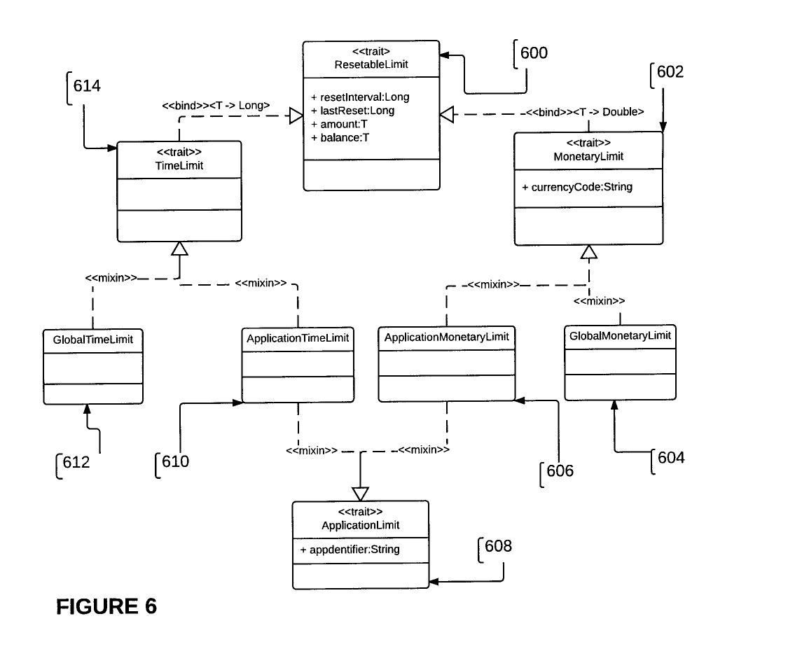

The field modified is balance 600 as referenced in FIG. 6. This field may be incremented by however many units (either money 606 or time 610 as with normal limits) the supervisor chooses if the desire is to reward 1810 behavior. In the case of penalization 1816 the system may decrement the balance 600 field by however many units the supervisor chooses but the system may not decrease below zero or create a deficit 1820.

An example of a beneficial use could involve a parent, Susan, who has set a limit of $20 for her daughter Lisa. To incentivize Lisa to clean her room and complete their homework by 5 pm Susan tells Lisa that she will give her an additional $5 if she gets these chores done in time. Lisa completes her chores at 4 pm so Susan opens the Mobile Monitoring Application and clicks on the “Reward” button and enters a value of $5. Lisa is then free to purchase additional gems in her favorite game. A manifestation of this system could involve a user interface, such as but not limited to, the Mobile Monitoring Application providing a button or input control to allow creating a bonus. The input control could, in some manifestations, be for preset amounts such as $5, $10, $20, or any other amount. In other manifestations it may involve an input that allows the user to set the amount directly. When a user selects to add a bonus the user interface would take the account or sub-account identifier and bonus amount, currency code, or amount standardized to a base currency such as US dollars, and in some manifestations, the time in which the bonus is available to be used and create a data package using JSON, XML, Protobuf, or any other text or binary based message format. The data package is sent to the API System over a network connection. The API System would take the data and using the account or sub-account identifier retrieve the monetary limit from a database, file system, or other storage medium. The API System would then take the balance field and add the bonus amount and, if supplied, add the bonus timer to the monetary limit record and persist again to the storage medium. The API System would then return a status to the user interface indicating that the bonus value had been added.

When the reset interval 600 is hit the balance field may be reset to the normally configured limit 600; the system does not allow a surplus.

In some embodiments, the engagement system 122 is configured to automatically increase and/or decrease the limits set on an account based on the application of rules from the rules engine indicating that positive patterns of behavior and/or negative patterns of behavior have been identified and/or tracked by the mobile monitoring application 100.

### Reporting of Limit Usage

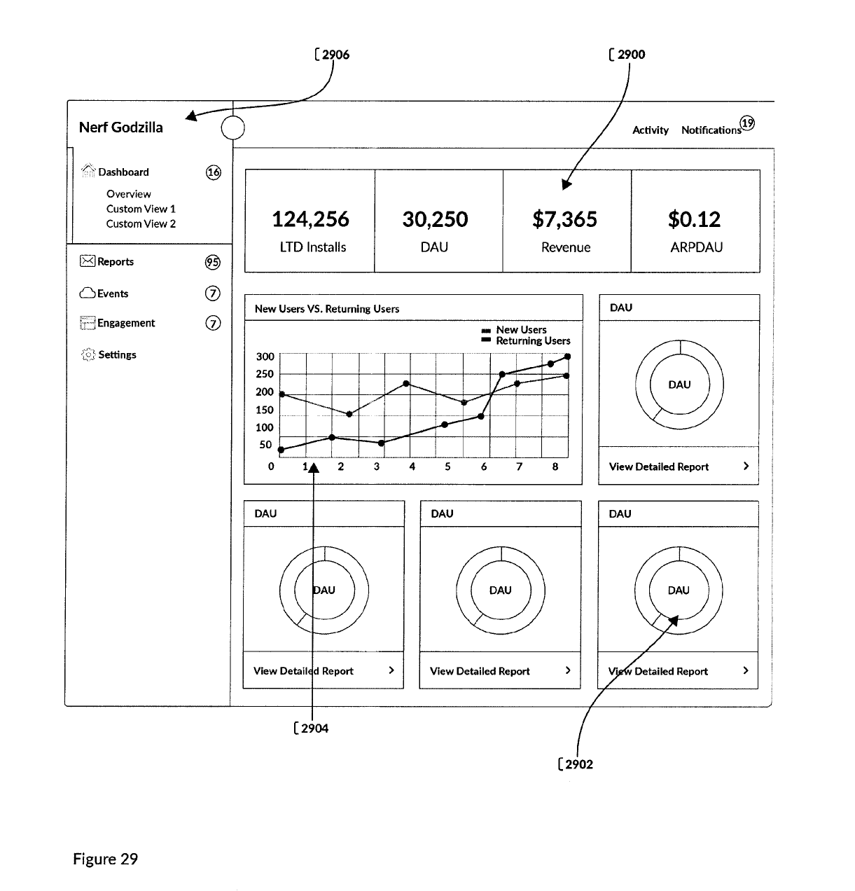

The system may be configured to provide multiple options for visualizing data associated with system usage as referenced in FIGS. 29, 30. These visualizations 2902 may be provided on an individual user basis through a mobile application 3000 or web portal. Aggregate usage data can be made available to application developers and studios through mobile or web dashboard applications. The visualizations and/or aggregate data may be provided to a variety of users depending on a particular set of rules, according to some embodiments.

The visualizations for the user can include, but may not be limited to, monetary usage, time usage, monetary usage trends, time usage trends, aggregate views of multiple applications, usage by time period, cumulative usage, comparative usage against aggregated system averages.

An example where this reporting would provide benefit to parents is to show a parent the upper, lower and median session times for children in the same age range as their child. A second viewpoint could be shown which is the session time for their child so a parent could visualize their child's average against the median. The visualization could also include a shaded warning area to allow a parent to quickly identify whether there is an issue of excessive device usage that they need to address with their child.

A manifestation of the system which effects the visualizations would involve the process of capturing data points from the API Client, API Protocol Processor, Mobile Monitoring Application and any other system endpoint that can offer relevant information. The data points may be identified by name, in some cases being sent along with the event data. The process of data collection in the API Client would involve creating a timer that is started on the initiation of a user session. The time of the session start would also be recorded in non-volatile memory, RAM, in an embedded database, or file system storage. A user session may be defined as a user loading the application or, in some cases, bringing the application to the forefront (focus). This timer will run until the end of the user session which may be defined as the close of the application, passivation of the application to the background, loss of focus, or in some cases a cessation of user interaction for a finite period of time. In some cases, it may be determined that the passivation of the application to the background, especially in the case of mobile phones, would not constitute an end of session if the user brings the application back to focus within a finite period of time.

This time period may be, as an example, in the case of checking a message or phone call, 90 seconds. This functionality could involve pausing the timer for the period of time the application is out of focus. At the end of the session the time and date of the end session is captured as well as the elapsed time. The API Client could choose to immediate package and send the event data to the API System or, in some cases, create a batch of events to send as a larger group to reduce network activity or to take advantage of compression algorithms. For the start and end session events this may also be consolidated into a single session event containing the start and end time.

On submission to the API system the API Client may also choose to send additional metadata such as device hardware specifics, network statistics, advertising and unique identifiers, financial information, or even free form key-value pairs of data. An example of another data point that is relevant would be financial transaction data. On a purchase attempt or completed purchase the API Client would capture the time, amount, currency code, or in some cases an amount converted to a base currency such as US dollars. Other data points could include information about the purchased items such as a unique identifier, a platform identifier, quantity, unit cost, or other relevant item data. Data about the monetary limit such as previous and current balance, limit amount, reset time; reset interval or other data may be included. Individual events could be captured for attempted purchase, cancelled purchase, completed purchase or may be consolidated into a single event capturing the relevant status. Events such as purchase attempts, which may exceed the limit balance, may also be captured. Data similar to the purchase event may also accompany the event indicating attempted purchase above limit amount. The process for submission of event data to the API System may involve the packaging of the event data in a JSON, XML, Protobuf, Thrift, or any other text or binary-based format. The data may also be compressed using a ZLib or other algorithm to save on transport costs. After the data is packaged then it is sent over the network, once the API Client determines a network connection is available, to the API system. The API System, on receipt of the event data, takes steps to unpack, decompress, or decode the data as necessary for the transport protocol. Once the data is available the API Processor may send the data over the network or through shared memory or inter-process communication to the Analytics System.

The Analytics system, at this point may store the event data in a database, file system, or other storage medium. In other manifestations, the Analytics System may pre-process the event data and provide additional data enrichment by retrieving associated data such as application name, identifier, demographics data, user data from a database, file system, in-memory cache, or other storage medium. This additional data may be added to the event record directly or using in an algorithm to add segment information to events such as users who have previously made purchases over $5. This segment information may be tagged onto the existing event data as it passes through the system before storage or it may be added at a later time through a separate data enrichment process, loaded from the storage medium and then saved again with the additional segment details.

The visualizations for application studios and developers can include, but are not be limited to, aggregate monetary usage 2900, monetary usage trends, time usage, user trends 2904, aggregate time usage, time usage trends, aggregate views of multiple applications, comparative usage against non-limit based users, session data, usage time data, data by time period.

An example where this type of visualization would be useful is for a game developer to see a trend over a period of time as to how much allowance has been allocated and how much allowance has been spent in game. The game developer could use these indicators to determine whether in-game marketing efforts or design changes were effective in increasing monetization.

Aside from visual representations of data, the system, through the API Client Library may expose the monetary limit as a field or method call. An example of this in use would be for Charles to download a game and while playing, the game would interrogate the Client API for the limit balance, in this case $20, and with this knowledge show a popup advertisement offering a $50 item for sale at $19.99.

A manifestation of the system would involve, as previously described, the API Client communicating with the API System to retrieve the monetary limit information for the current user. Part of the data received would include the current limit balance as a currency value. The data could, in some cases, be presented to the application implementing the APII Client as an application as offered by the implementing programming language libraries. In other cases, the API Client can provide an individual method to retrieve the current limit balance. The method arguments could include the account or limit unique identifier or in other cases the API Client could use stored values.

The balance returned could take the form of a decimal value indication fractional monetary amounts or the balance may be converted to a base integer by dropping the fractional amount or multiplying by 100 to drop the fractional digits. Another manifestation would involve returning the balance amount during the session initialization routines.

For example, this data may be particularly useful for advertising companies, marketing companies, data collection companies, etc., for determining usage based tracking and/or statistical modelling. In some embodiments, the system may be configured to provide and/or interact with this data and/or external data through various APIs with external systems.

In some embodiments, the system may be further configured to develop visualizations and/or aggregate data using a combination of internal and external data.

An example of this type of data aggregation could involve the importation of demographic information including median salaries and household income by geographic area to overlay the amount of money allocated to a limit indexed against the purchasing power of the same demographic region.

Another example of using external data could be the use of recommended standards for time spent in-game or online as provided by psychologists or other recognized experts. These standards could be used to notify a user if their behaviour deviates from recognized norms.

A manifestation of the system would involve the API or Analytics System, on capturing and accumulating time in the application through session events, periodically querying the database, file system, in-memory cache, or other storage medium for a list of accounts or sub-accounts with an elapsed time usage greater than the amount deemed to be normal or standard time usage. If the time usage has been exceeded then either a flag is added to the account in the database, or other storage medium, or an internal process is invoked to send a SMS, email, push notification using a mobile or operating system platform provider, or through a network connection to the client user interface.

The user interface could use the native platform's notification scheme and inject the notification to be displayed or can visually show an indicator or launch a dialog to inform the user of excessive time usage. Another option is to, in the Analytics or API System, maintain an in-memory counter of elapsed time and as data comes in increment the counter up until the point where the counter value is greater than the standard or recommended amount of time spent in app. The timer would be incremented based on session durations captured in the session events sent to the system as described in prior sections. This process could operate as a “wire-tap” and access the duration value as the event is in transit over a message bus or other point-to-point or broadcast transport.

### Virtual Currency Exchange

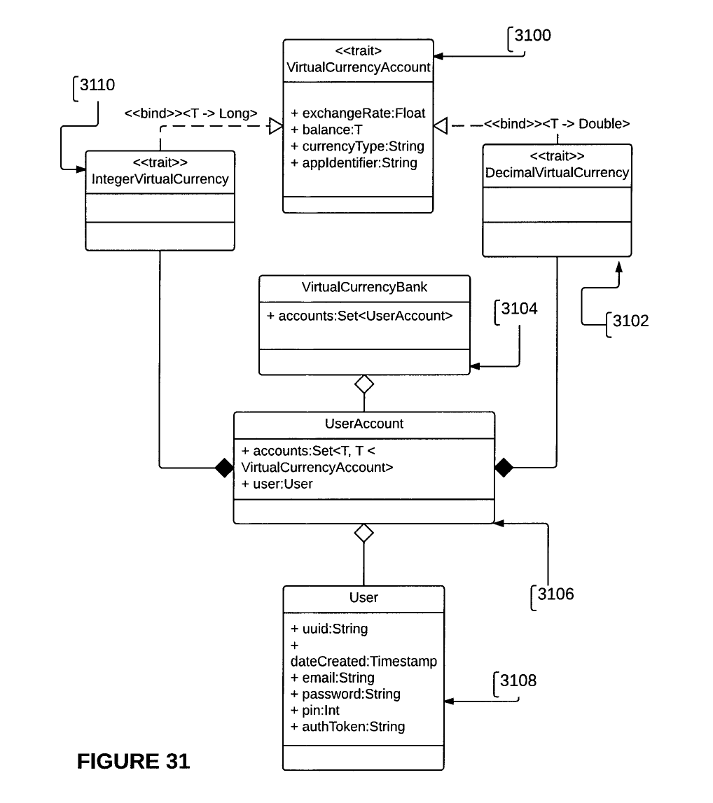

In some embodiments, a virtual currency exchange may be provided as a mechanism for limiting monetary usage in applications as referenced in FIG. 31. A user could pre-fund a virtual currency account 3100 by purchasing an amount of virtual currency in an application with real currency. This virtual currency could be maintained as a debit account 3106. Monetary limits could be set as real currency over time as a normal monetary limit. The actual amount of virtual currency allocated per time period as a limit could be accomplished by dividing the number of units of virtual currency purchased by the real currency purchase price to get a base unit exchange rate. This base unit exchange rate could then be multiplied by the allotted real currency limit to give an equivalent unit amount of virtual currency. As applications, in some cases, have multiple virtual currencies, the type of currency may be stored along with the account.

### Enforcing Virtual Currency Limits

When a user attempts to make a purchase valued in virtual currency, the system may be configured to verify the remaining virtual currency balance is greater than the desired purchase amount. If the amount is less that the desired purchase amount, the system may also be configured to subtract the purchase amount from the remaining virtual currency balance and the purchase transaction can be completed and confirmed.

If the desired purchase amount is greater than the remaining balance, the Client API may be configured to notify the calling code that the balance may be insufficient which may provide the option to the application designer to either suppress the purchase attempt of notify the user of insufficient balance.

### Use Cases

An example use case is provided below, for non-limiting illustrative purposes:

In this use case, there is a game X that a user is able to download and play. There are virtual currencies, in the form of coins, and the game may include the unlocking of levels, rewarding of coins, and various elements in game that can be purchased using the virtual currencies.

A user downloads game X and proceeds to play. The user may be rewarded 500 coins at the very beginning. They play for five minutes and earn another 250 coins. The user comes back the next day and continues play. They have unlocked the next level and may be presented a quest to build two buildings and plant ten trees. The user buys the buildings for 250 coins each leaving 250 coins remaining. The user may be told the buildings may take 24 hours to complete construction but may be presented with the option to spend 50 coins to immediately complete the process. The user chooses to complete the process immediately and may be left with 150 coins remaining. The user then goes to plant the trees which cost 25 coins each. The user may be able to plant 6 trees until he runs out of coins. The system may be configured to prominently display an in-game marketing dialog advertising a one-time sale of 1000 coins for $10.

### API System

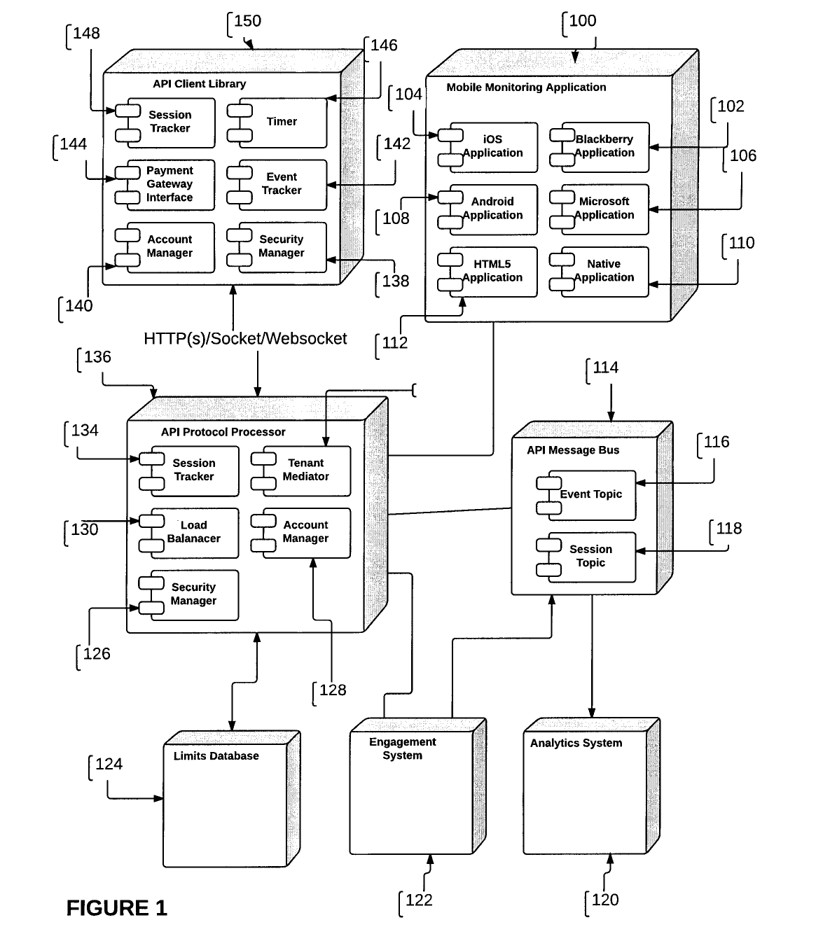

The API System, as referenced in FIG. 1, may be a subsystem of the Controlling System that may be responsible for interaction with the authorization and management systems. The subcomponents each have more specific functions as descried below.

### Mobile Monitoring Application

The Mobile Monitoring Application 100 may be, in some embodiments, a native mobile or embedded application that allows a user to view individual behavioral data as well as comparisons against system averages. This tool can be used to configure limits in a similar fashion to the authorization system but in a simpler fashion. This tool could also be used to facilitate user registration. The viewpoints may be helpful for enabling a user to be able to quickly access multiple applications settings and data.

The Mobile Monitoring Application 100 may also be configured to cause various effects on the user's computing device and/or track various aspects of usage, for example, of the device and/or of the user's activities in relation to various applications interfacing and/or interacting on/with the user's computing device. For example, the Mobile Monitoring Application 100 may be used to turn off the device, prevent transactions from occurring, issuing notifications to a third party device and/or system, etc. The Mobile Monitoring Application 100 may also track usage of the computing device and/or receive various elements of information from sensors on-board the device, such as a GPS, WiFi, etc. This information, for example, may ultimately be used by the system to determine what behaviors a user has undertaken in relation to various electronic applications which may be resident on memory on the device.

The Mobile Monitoring Application 100 may also be configured to obtain various elements of information about the user based on information stored on the user's computing device. For example, information related to purchase history, age, name, location, etc., may be derived from other applications, metadata, existing profiles or storage. The Mobile Monitoring Application 100 may also be configured to detect patterns of activity or behavior, based on rules provided by the rules engine.

Information related to the user's use of the device, various applications, purchase history and/or other related characteristics (e.g., location data, last usage information, power state, Wifi usage) may be provided in the form of various electronic indicia to the controlling system and/or other components of the system.

The Mobile Monitoring Application 100 may also be utilized to manually enact changes related to a user's profile and/or usage limits (e.g., virtual currency limits and/or virtual time limits).

Another use of the monitoring application may be to remotely provide a reward of temporarily increased limits or a penalty of reduced time or monetary limits. This use may advantageously allow a proactive, hands-off mechanism to utilize the system in an attempt to modify the behavior of the supervisee through the application/monitoring/enforcement of behavior through various rules.

In some embodiments, the Mobile Monitoring Application may reside on the same device as the application in which limits are being applied.

Another use of the Mobile Monitoring Application is to communicate and transmit data such as, but not limited to, user accounts, limit settings and game identifiers to the API Client Library within the application being monitored. In some embodiments, the Mobile Monitoring Application may use the Apple iOS Inter-App Communication scheme to facilitate communication with the application being limited. In some embodiments, the Mobile Monitoring Application may use the Android Content Provider framework to expose data such as, but not limited to, user account identifiers and limit settings. In some embodiments, the Mobile Monitoring Application may, in some manifestations, use the x-callback-url specification to allow bi-directional communication with the application being limited. In other manifestations a custom URL communication scheme may be used which leverages the inter-app communication facilities available within iOS. The physical environment provided by an iOS device has a security sandbox within each application runs. To prevent tampering of application data and to reduce the possibility of rogue apps taking over a device the iOS sandbox is extremely restrictive and an application may only access its own data. It cannot share files, open sockets to or access shared memory locations with other applications. This is extremely limiting as far as allowing app-to-app communication. The added complexity of relying on a URL communication scheme is limiting in its sole availability of querystring data and that each app is launched when “communicating”. This can be a jarring experience for a device user so care must be used in reducing the communication between the application and the Mobile Monitoring Application.

A manifestation of the Mobile Monitoring Application and Client API integration, in the case of Apple iOS, would involve the Mobile Monitoring Application registering a custom URL scheme with the device operating system. The process to check for application pairing starts with the application instantiating the Client API on an application initialization hook provided as part of the operating system libraries. Once the Client API is instantiated it would query the operating system services to determine if an application is installed that is capable of opening the URL as defined by the Mobile Monitoring Application. If there is no application registered then the Client API assumes that the Mobile Monitoring Application does not exist and that no limits are set. If the operating system services indicate that there is an application registered then the API Client would execute a method on the operating systems services to open the URL.

In the case of using the x-callback-url scheme, the Client API would also include details that facilitate the Mobile Monitoring Application responding. These additional fields may include a command name, a transaction identifier or an identifier that allows the opening of the application containing the Client API. These data elements would be added to the URL as querystring parameters. The operating system would then move the calling application to the background and launch the Mobile Monitoring Application. The Mobile Monitoring Application would attach a routine to the initialization hooks provided by the operating system libraries and determine if the application was loaded through user interaction or using the custom URL scheme.

If the custom URL scheme were used then the Mobile Monitoring Application would parse any provided parameters and determine if the URL indicates a pairing request. If it is a pairing request then the Mobile Monitoring Application would retrieve the unique identifiers for the accounts or sub-accounts and unique identifiers for the limits from an embedded database, file system, non-volatile memory or other storage medium. In some manifestations the Mobile Monitoring Application may directly pass the limit values in the response. The identifiers or limit values are then added to a custom URL registered with the operating system by the application containing the Client API. The data elements are added as part of the querystring and any other parameters passed as part of the initial request that facilitates the callback, such as a transaction id, are included in the querystring. The Mobile Monitoring Application would then ask the operating system services to open the constructed URL. The operating system would then move the Mobile Monitoring Application to the background. On the launch or the application containing the Client API, a similar initialization hook is used to determine if the application is able to handle the URL. As part of this routine, which examines the URL name and contents the application, would determine that the Client API is capable and responsible for handling the URL and forwards all relevant data and control to the Client API. The Client API then parses the URL and extracts the parameter values that may include the unique identifiers or limit values.

The Client API could then register that limits are applied and then store the unique identifiers or limit values in an embedded database, file system, non-volatile memory or other storage medium for later use. As mobile devices, in some cases, allow full access to storage areas, it may be necessary to encrypt the identifiers in storage, obfuscate file names, or store checksums along with the data or in a separate hidden location to ensure stored values are not tampered with by device users. The Client API would then pass control back to the application. The physical environment of numerous mobile device platforms and the different mechanisms within which they sandbox application access and communication make implementation complex and specific to each device platform. Even within Android devices the differences between Samsung, Amazon, and Google application programming interfaces offer differing support and implementation paths.

A manifestation of the Mobile Monitoring Application and Client API integration, in the case of Android would create a content provider, in some cases an embedded database or other storage medium. The Mobile Monitoring Application would, on account or limit creation or on authentication, insert account, sub-account or limit unique identifiers in the content provider storage medium. In some instances the limit values themselves may be inserted directly in the content provider. The process to check for application pairing starts with the application instantiating the Client API on an application initialization hook provided as part of the operating system libraries. Once the Client API is instantiated it checks with the operating system services, using provider names and identifier as registered by the Mobile Monitoring Application, whether there is a content provider registered that matches the Mobile Monitoring Application. If there is no content provider registered then the Client API assumes no limits are to be applied. If there is a content provider available then the Client API is able to access the content provider and extract the unique identifiers or limit values for subsequent use as defined in other sections.

The content provider functionality may require the granting of permissions between application environments wherein the application accessing the content provider must be granted permission or given access authority by the Mobile Monitoring Application. Since the data in the content provider should only be modified through the Mobile Monitoring Application only read-only authority is given to external applications executing within the same physical environment.

The Mobile Monitoring Application may show visual representations of remaining limit balance. A countdown timer may also be displayed to inform the remaining time before the limit balance is reset.

An example of this in use would be Susan, a parent of a nine year old, who had set a weekly allowance of $10 for her daughter Lisa. Lisa had already spent $9 and pestered her mother, asking her when she could have more. Susan opens the Mobile Monitoring Application and immediately sees a timer indicating that Lisa's allowance would renew in 2 days and 4 hours. She then relays this information to Lisa in an attempt to silence her for two more days.

The Mobile Monitoring Application may display a list of applications which have the Client API integrated. The user may be directed to the respective “App Store” allowing the user to download the selected application. A manifestation of the system would, from the API System, return a list of supported applications, the data contained in the list would include the URL to the respective app store, application name, icon file or URL, app description.

The Mobile Monitoring Application may display relevant information about each of the limited applications. Such information may include ratings, reviews, content ratings, age rating, suitability, or warnings.

The Mobile Monitoring Application may show a visual representation of the elapsed session time spent by each sub-account in the limited application. The session time may be displayed contrasted with an aggregate of session times across all, or limited subsets, of sub-accounts in the system. The session time aggregates may be displayed as, but not limited to, median or average values. A manifestation of a system that displays aggregate values would involve the capture of application session times for all users in the system. The aggregate values would be calculated by generating time series averages, the windows of which could be at hour, day week or month intervals, for all users by running functions to find averages, population distributions, median, mode or other statistically relevant values. Other input criteria to the function may include data such as user's age, gender, application preferences, geographic location or other limiting data points.

Aggregates may be generated for these subsets as well. In some manifestations of the system these aggregates will be calculated as an offline process, the results of which are stored in a database, file system, or other storage medium. In other manifestations the aggregates will be calculated on a request-by-request basis. The Mobile Monitoring Application would request the aggregate values from the API System over the network and may use information such as the current account's age, gender, geographic location, and application preferences in the request to return a narrower subset of aggregate values.

The Mobile Monitoring Application then when request the cumulative session time by specific time window, be it hour, week or month intervals from the API System which would request the information from the Analytics System or from a database, file system or other storage medium. The Mobile Monitoring Application with both aggregate and individual values can now visually display where the individual fits within the aggregate. A bell curve may be shown or even percentile values may make up part of the visualization.

The Mobile Monitoring Application may show a visual representation of the total money spent by each sub-account in the limited application. The money spent may be displayed contrasted with an aggregate of money spent across all, or a limited subset, of sub-accounts in the system. The money spent aggregates may be displayed as, but not limited to, median or average values. This may also include a transaction history listing of previous purchases.

The visualizations in the Mobile Monitoring Application may visually indicate when the session time or money spent by each sub-account differs from an average or median aggregate by a deviation amount that may be configured on the controlling system or stored locally on the Mobile Monitoring Application.

These visualizations may be of use to parents to determine whether their children are spending too much time or money and allow for intervention of problem behaviour.

### API Protocol Processor

The API Protocol Processor 136 may be a functional endpoint for the API System. The API Protocol Processor 136 may provide HTTP(s) and in some embodiments, TCP and/or UDP endpoints. The transport payload content in some embodiments may consist of binary representations such as, but not limited to, Protocol Buffers, Thrift, BSON, Avro, and/or textual formats such as JSON.

As an example a JSON formatted payload may resemble the following structure:

{
api_key : “7fb6552e-83a6-4e9f-b68c-cf12157f8ecb”,
account_id : “376cc4b6-abca-4787-89f2-055591f7666c”,
limits : [
{
type : “monetary”,
balance : 12.50,
currency_code : “USA”,
reset_datetime : “2014-06-09T19:07:40+00:00”
},
{
type : “time”,
balance : 62,
reset_datetime : “2014-06-09T19:07:40+00:00”
}
]
}

The subcomponents themselves may be shown in a logical arrangement but may have the same functionality as if physically distributed. In a distributed environment, communication may be provided through web services, RPC, and/or other remote method invocation techniques.

### Session Tracker

The Session Tracker 134 may be configured to provide similar functionality to the session tracker in the API client library but may also be configured to manage an account for usage based on connected clients. The Session Tracker 134 may be used in situations where it may be potentially unwieldy to integrate a client library.

### Account Manager

The Account Manager 128 may be configured to interface with the Limits Database 124 and may provide the create/read/update/delete functionality that may be useful for the managing limits, rules, and/or user accounts.

### Security Manager

The Security Manager 126 may be configured to handle email and username authentication by maintaining one-way hashed passwords. Other types of security and authentication may be utilized, and in some embodiments, there may also be no authentication. The authentication data may be sent over a SSL encrypted transport and/or using a public key encrypted payload. Other types of transports, and encryptions may also be utilized.

The system may also be configured for multi-factor authentication and/or account verification through OpenID and OAuth channels.

### Load Balancer

The Load Balancer 130 component may be configured to distribute protocol traffic between multiple API Protocol Processors based on round robin, application specific, or weighted algorithms.

### Tenant Mediator

The Tenant Mediator 132 may be configured to allow support for implementations by multiple applications and application developers. This component can be configured to limit access to services for authorized applications as well as providing application or application developer specific services and routing. The Tenant Mediator 132 may be configured to rely on the application API key to authorize access and to route traffic. Access may be denied to invalid API keys. Embedded within the API key may be the specific application identifier 608 704 used to associate limits.

### API Client Library

The API Client Library 150 may be embedded by developers in their applications so that one or more sets of behavioral rules can be applied/monitored/enforced. The library, in some embodiments, may be available in native platform code as iOS, Microsoft Windows, or Android libraries as well as plugins for platform tools such as Unity3D, Cocos2D, Corona, etc. In other embodiments, the libraries may be integrated into the device OS itself and offered as system library calls. Non-native platform code may also be used, for example, various cross-platform code.

The API Client Library 150 may be configured to provide pre-built or template based user interface components that may be helpful in allowing low effort integration into existing applications. In some embodiments, library function calls that may be configured for equivalent functionality may be provided to help allow developers release white label implementations.

The API Client Library embedded within the application being limited may communicate with the Mobile Monitoring Application to facilitate application discovery and notify the Mobile Monitoring Application that it is co-located on the same device. In some embodiments, the Client API may use the Android Content Provider framework to determine whether the Mobile Monitoring Application is co-located on the same device. In some embodiments, the Client API may use the Apple iOS Inter-App Communication scheme to determine whether the Mobile Monitoring Application is co-located on the same device.

### Session Tracker

The Session Tracker 148 component may be initiated by a startSession API call wherein the library may be configured to record the current date/time and starts a timer to record elapsed usage time. If the user of a device switches the application into the background, the library may be configured to detect the switching and determine based on the duration in background whether to record the end of the current session or if it is a continuation of the current session. This may be a common scenario on a mobile device due to context switching, (e.g. a user switches application for various purposes, including checking email, taking a phone call). On completion of a session, the elapsed time may be recorded and the library may flush the session start time and duration to the system along with any other metadata required or provided.

The Session Tracker 148 may also be configured to collect device information such as platform, model, software revisions that may be used to provide analytics and quality metrics for developers. Push notification tokens may also be collected for later use in engagement. The Session Tracker 148 may be also used to assist application users, if they own more than a single device, in differentiating multiple devices within the mobile monitoring and management application.

### Payment Gateway Interface

The Payment Gateway Interface 144 may be configured to provide an abstraction to the platform payment processor for checking the remaining monetary limit balance and to authorize and/or disallow the purchase from occurring and/or completing.

The Payment Gateway Interface 144 may have access to the monetary limit balance and may be configured to report, through the Event Tracker, one or more financial transactions.

### Account Manager

The Account Manager 140 component may be configured for generating new user accounts and sub-accounts, modifying existing accounts and sub-accounts, as well as the creation and modification of the monetary and time limits.

### Security Manager

The Security Manager 138 may be configured for user account authentication, authorization, and encryption. Various techniques may be utilized to manage the security of various elements of the system, for example, to prevent code injections, denial of service attacks, the running of unauthorized code, etc.

SSL communication may be used due to the risk of payload manipulation during transport as well as to prevent of wire sniffing in attempts to access user credentials.

For example, user account authentication can be based on username, email or through a multi-factor authentication scheme such as OpenID or OAuth supported by Google™, Facebook™, Twitter™, etc.

Payload signatures may be used to ensure that message content or headers have not been modified in transit. An example of this type of signature is providing an HMAC-SHA256 hash of HTTP body data as well as HTTP headers and URL path information.

### Event Tracker

The Event Tracker 142 component may be configured to allow the library implementer to capture quality, error, monetary, and behavioral data that may assist in the monitoring and reporting of user behavior and system health. These events may have a name, time of occurrence, as well as key-value pairs of associated data.

### Timer

The Timer 146 component may be used by the Session Tracker 148 and Event Tracker 142 components and may be configured to provide means for calculating elapsed and current time. Implementations may feature network time protocol synchronization or calculations involving drift from system time. For example, one or more devices connected to the system or otherwise interoperating with the system may have different configurations regarding time and date.

### API Message Bus

The API Message Bus 114 may be a high performance message queue such as Kafka or RabbitMQ used to provide a measure of elasticity and reliability in between the protocol system and the analytics 120 and engagement 122 systems.

### Event Topic Repository

The Event Topic Repository 116 may be configured as a repository for events sent to the system by the event tracker 142 components and may interact with the analytics system 120.

### Session Topic

The Session Topic Repository 118 may be configured as a repository for one or more session logs sent to the system by the session tracker 134 components and may interact with the analytics system 120.

### Limits Database

The Limits Database 124 may be a database implemented within a NoSQL™ solution such as MongoDB™, Cassandra™, Couchbase™, DynamoDB™, HBase™, or in some embodiments, a SQL solution such as MySQL™, SglServer™, Oracle™, and/or IBM DB2™. As referenced in FIGS. 6, 7, 28, the database may hold the persistent representations of the object model. The database may be in other formats as well, including flat files, comma separated values, Excel spreadsheets, etc. The database may be configured to store records, and in some embodiments, relationships may also be defined between records. Various operations may also be conducted on the information stored with the database.

### User Accounts

User Account 2808 2812 data may be maintained in the database. Attributes may be collected to support user authentication, reporting, notification as well as for user engagement. To support a parent-child account structure the system may also be configured for sub-accounts to be defined with references back to the parent account. Sub-accounts may similarly feature an authentication and identifier structure.

### Developer Accounts

To support application creation and application settings, the system may be configured to store developer information 2800. This information may include, for example, user accounts 2814, authentication 2812, application 2804, application API key, and supporting configuration data.

### Limit Profiles

Limit Profiles 2810 may contain, for both monetary limits 604 606 and time limits 610 612, an amount, balance, and time interval for reset, and time of last reset 600. As referenced in FIG. 6, the data structures may closely match the object structure.

The application of the limits can be applied on a single application 606 610 basis or on an overriding global 604 612 basis to set limits across multiple applications. A provision for applying limits to a category or categories of application could also be covered within this model.

An example of applying limits to a category would be if a parent set a $20 weekly limit for applications categorized as “educational” and a $10 weekly limit for games within the “strategy” category, and a further $5 allowance for games within the “arcade” category.

As referenced in the User Accounts section, sub-accounts may be optionally provided by the system, and in the case of a parent-child account structure, the limit profiles could be associated to the sub-accounts, not the master account.

### Exclusion Profiles

Exclusion profiles, as referenced in FIG. 7, may allow a user to define multiple time periods 700 consisting of start and end times in conjunction with the day of week 702 to either authorize or disallow application usage during the defined time blocks 704, in effect, creating inclusionary or exclusionary windows of application usage.

The system could be configured to allow overrides 708 to be defined and configurable on a user specific basis or to be pre-populated with locale specific holidays 710.

### Analytics System

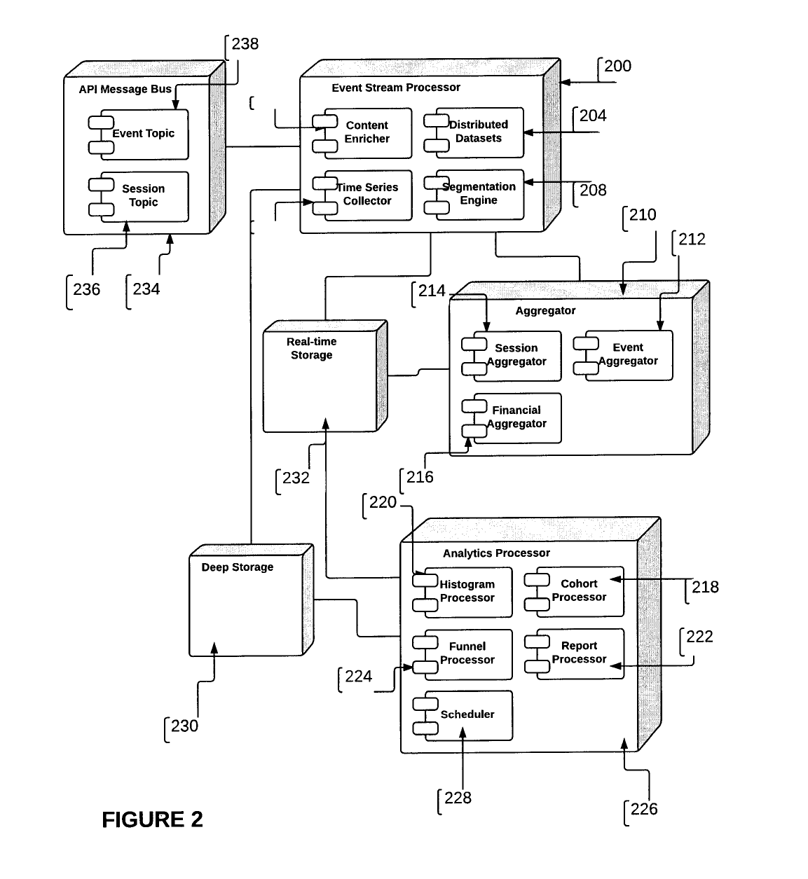

The Analytics System, as referenced in FIG. 2, may include multiple subsystems 200 210 226 230 232 234 that accumulate various data and calculate various trends, such as usage data and calculate time series usage and monetary trends, among others. This information may form the basis on which visualizations are developed in the dashboard system for developers as well as the basis for providing comparisons and averages for users to view within the management and monitoring system.

### API Message Bus

The API Message Bus 234 may be a message queue such as Kafka or RabbitMQ and may be configured to provide a measure of elasticity and reliability in between the protocol system and the analytics and engagement systems.

### Event Topic Repository

The Event Topic Repository 238 may be a repository for one or more events sent to the system by the event tracker 142 components and may interact with the event stream processor 200.

### Session Topic

The Session Topic Repository 236 may be a repository for session logs sent to the system by the session tracker 134 components and may interact with the event stream processor 200.

### Aggregator

The Aggregator 210 subsystem may be configured to receive various data (including for example, enriched data) by the event stream processor and may be configured to perform various aggregations, such as time series data aggregation windowed on minute, quarter hour, half hour, hourly, daily, weekly, monthly, and life to date intervals. These aggregations may provide near real-time views of data and may be useful to inform developers on application performance or of potential issues and may be stored in the Real-time Storage 232 subsystem.

### Session Aggregator

The Session Aggregator 214 component may be configured to perform data aggregations on session specific data such as average session length, average number of sessions, average usage per day, etc.

### Event Aggregator

The Event Aggregator 212 component may be configured to perform data aggregation on event data such as average number of occurrences, count of occurrences, and average number of occurrences per session, etc.

### Financial Aggregator

The Session Aggregator 216 component may be configured to perform data aggregation on financial data such as revenue, average purchase amount, number of converting users, number of paying users, items purchased, total monetary limit remaining, percentage of limit usage, etc.

### Event Stream Processor

The Event Stream Processor 200 subsystem may be configured for interacting with the queues on the message bus 238 and enriching the data as the data flows through the system. For example, the NoSQL and Big Data systems described in the Real-time Storage 232 and Deep Storage 230 subsystems may require data to be de-normalized and flattened so additional fields can be attached to the event and session payloads before processing and storage. Some data, due to volume, may require windowed aggregations as the data is received prior to being sent to the aggregator. In some embodiments, the event stream processor may consist of Spark, Storm, or Esper libraries.

### Content Enricher

The Content Enricher 202 may be configured for the purpose of augmenting the event and session data with relevant attribute and metadata as data flows through the system. To maintain a small payload, not all attributes may be present as they come up from the client library and because of the complications with joins and relations in the deep storage, it may be advantageous to enrich the data before storing.

### Distributed Datasets

Given potentially large user volumes and volumes of data received from various applications, it may be advantageous that the system be configured such that datasets are maintained in-memory for calculations. The configuration may be accomplished, for example, with resilient distributed datasets 204 and cluster computing technology.

### Segmentation Engine

A Segmentation Engine 208 may be configured to define and/or apply tags that may further augment the data and associate it to a defined segment or category. Examples segments could include users that have limits in place, users that have spent money, users without limits, and/or users that have exceeded limits.

These segments may be important for notification and engagement purposes as well as to provide the metrics and visualizations needed for monitoring. In some embodiments, these tags may be defined by various users of the system and/or associated with one or more rules. For example, tags could be applied to data related to productivity applications, and a supervisor may be interested in reviewing data from those applications as opposed to other types of applications.

### Time Series Collector

The Time Series Collector 206 may be configured to maintain a rolling time window based dataset that groups data packages based on the timestamp and start and end times of each bucket. The Time Series Collector 106 may allow a measure of preprocessing and may reduce high disk I/O by maintaining the latest groupings in memory.

### Analytics Processor

The Analytics Processor 226 subsystem may be configured to handle long running analytical calculations and data transformation that happens at lower frequencies than the real-time calculations performed by the Aggregator 210. This subsystem, in some embodiments, may include of a job tracker such as Zookeeper as well as a high level Map/Reduce interface such as Hive, Pig, Impala, or Shark.

### Histogram Processor

The Histogram Processor 220 may be configured to calculate the interval distribution of commonly accessed fields such as bucketed numeric values associated to event keys, geographic distribution, limit balances, limit settings, user profiles, etc. These histograms may be processed on a scheduled basis to eliminate excessive system load due to on-demand requests. Histograms may be an important visualization within the dashboard system.

### Cohort Processor

The Cohort Processor 218 may be configured to tracks metrics based on the install date of the application or sign-up date of the user. The cohort metrics provides rolling behavior of users and may be useful in calculating differences in application usage over time. Normal cohort metrics may be calculated out to, but does not have to be limited to, 30 days.

### Funnel Processor

The Funnel Processor 224 may be configured to track a user's path through a series of steps and measuring the number of users that directly or indirectly trigger each step. This may be used, for example, to help measure various metrics related to application flows like user sign up, tutorial progress, viewing an item in store through the purchase process. Funnels may be potentially advantageous for user engagement and to help developers tune the application interface based on analytics feedback.

### Report Processor

The Report Processor 222 may be configured to facilitate ad-hoc and/or pre-defined, complex reports. Complex reports may have a higher processing impact. The Report Processor 222 may be configured to distribute the query processing across multiple nodes in deep storage.

### Scheduler

The Scheduler 226 may be configured to execute the cohort, funnel, and report processors on a timed basis. Operation in such a way may help ensure that data may be available when/near when the user requires the data and may reduce the high impact of multiple users executing the same queries. The scheduler 226 also may also have workflow capabilities that allow the scheduler 226 to restart failed or interrupted jobs.

### Real-time Storage

Real-time Storage 232, in some embodiments, may be NoSQL or in-memory databases that allow low cost, high throughput access to frequently requested data. Data aggregations and time series aggregates may be stored in Real-time storage as may be user information relevant to segment analysis. Other types of storage, including SQL servers or distributed resources may also be utilized, according to some embodiments.

### Deep Storage

The Deep Storage 230 subsystem, in some embodiments, may be a Hadoop clustered file system that allows low cost, resilient storage of large volumes of unstructured data. Various other types of file systems may be utilized. Records can be structured, semi-structured and/or unstructured, in various formats. Data formats such as Parquet may be used to provide efficient access to semi-structured records.

In some embodiments, as raw session and event data may be not necessary for real-time processing, it may be archived in deep storage and accessible by the analytics processor or exportable for external analysis.

### Dashboard System

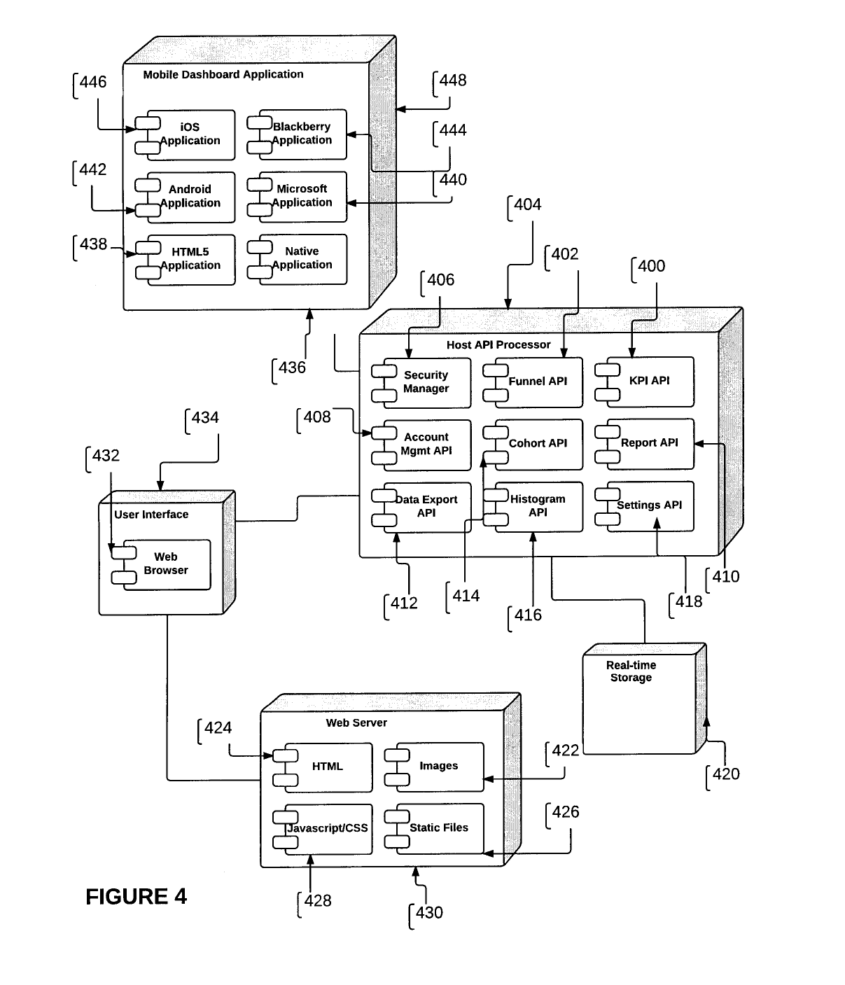

The Dashboard System 302, as referenced in FIGS. 4, 29 may be the main web 438 and mobile application 452 portals for developers to manage their applications, users, view analytical data, and engage with the application users. The dashboard 2906 may feature a main page with numerous graphs 2902 2904 and statistics 2900 to provide developers an indication of performance and trends at a quick glance.

The dashboard features similar authentication strategies to other components within the system but may be configured to provide additional authorization mechanisms and role based permissions. These authentication strategies may allow developers to define an organizational strategy that only allows authorized users to perform specific functions and have access to restricted data.

### Host API Processor

The Host API Processor 404 may be configured to perform similar functions to the client API processor but in this case the clients may be the dashboard application, mobile monitoring application, and in some cases raw API access by developers or application store publishers who desire tighter integration.

The technologies leveraged may be RESTful web services using HTTP(s) and JSON, among others. The host API may also feature comma separated value (CSV) formats wherever data export functions may be necessary.

### Security Manager

The Security Manager 406 may be configured for user account authentication, authorization, and encryption. SSL communication may be used due to the risk of payload manipulation during transport as well as prevention of wire sniffing in attempts to access user credentials.

User account authentication can be based on username, email or through a multi-factor authentication scheme such as OpenID or OAuth supported by Google, Facebook, Twitter, et al.

### Funnel API

The Funnel API 402 may be configured to provide create, read, update, and delete functionality for funnel analysis within the system. Users can define new funnels, edit existing, and delete unused funnels. The main function may be to provide structured funnel data used in graphs and visualizations within the dashboard.

### Account Management API

The Account Management API 408 may be configured to provide create, read, update, and delete functionality for developer user accounts within the system. Users can define new users, edit existing, and delete unused users. An additional feature may be the ability to assign roles and permissions to users that may be leveraged throughout the dashboard and host API. Disabling users may be also supported to provide efficient means of locking accounts.

### Cohort API

The Cohort API 414 may be configured to provide read-only and limited drill-down cohort analysis within the system. The function may be to provide structured cohort data used in graphs and visualizations within the dashboard.

### Histogram API

The Histogram API 416 may be configured to provide drill-down histogram analysis within the system. The function may be to provide structured histogram data used in graphs and visualizations within the dashboard.

### Report API

The Report API 410 may be configured to provide create, read, update, and delete functionality for reporting and ad-hoc analysis within the system. The Report API 410 may be configured to allow users to define save drill-down views as saved reports, edit existing, and delete unused reports, etc. The function may be to provide structured report data used in graphs and visualizations within the dashboard.

### Settings API

The Settings API 418 may be configured to provide create, read, update, and delete functionality for developer's applications within the system. Users can define new applications, edit existing, and delete unused applications. Another function of the API may be to generate the API keys suitable for data access.

### KPI API

The KPI API 400 may be configured to provide functionality for key performance indicator analysis within the system. The main function may be to provide structured KPI data used in graphs and visualizations within the dashboard.

### Data Export API

The Data Export API 412 may be configured to provide developers the ability to export raw data groupings if they wish to perform their own in-depth analysis or mix with other datasets they have available to gain additional insights not offered through the system.

### Web Server

The Web Server 430 component may be configured for delivering static content such as images 422, CSS 428, Javascript libraries 428, HTML 424, or other static file 426 content. Technologies such as Apache or Nginx may be leveraged to serve content along with caching proxy server technology such as Squid or even a content distribution network if applicable.

### Real-Time Storage

Real-time Storage 420, in some embodiments, may be NoSQL or in-memory databases that allow low cost, high throughput access to frequently requested data. Data aggregations and time series aggregates may be stored in Real-time storage as may be user information relevant to segment analysis. Other types of storage may also be utilized, such as SQL databases, Excel spreadsheets, comma separated values, flat files, etc., according to some embodiments.

### User Interface

The main User Interface 434 may be in the form of a web portal 432 comprising the dashboard and other utilities. The dashboard may be configured to provide various navigation tools, allow chat and report sharing functionality amongst connected developer users. The user interface 434 may be configured to allow developers to view reports with the same time ranges and metrics to potentially reduce confusion amongst peers.

### Mobile Dashboard Application

The Mobile Dashboard Application 448 may be used to provide developers with quick access to dashboard data, KPIs, and settings. Similar functionality to the web dashboard may be provided but in reduced capacity. In some embodiments, implementations may be provided for iOS 446, Android 442 (Google and Amazon), Microsoft 440, Blackberry 444, packaged HTML5 438, or other native 436 platform.

### Engagement System

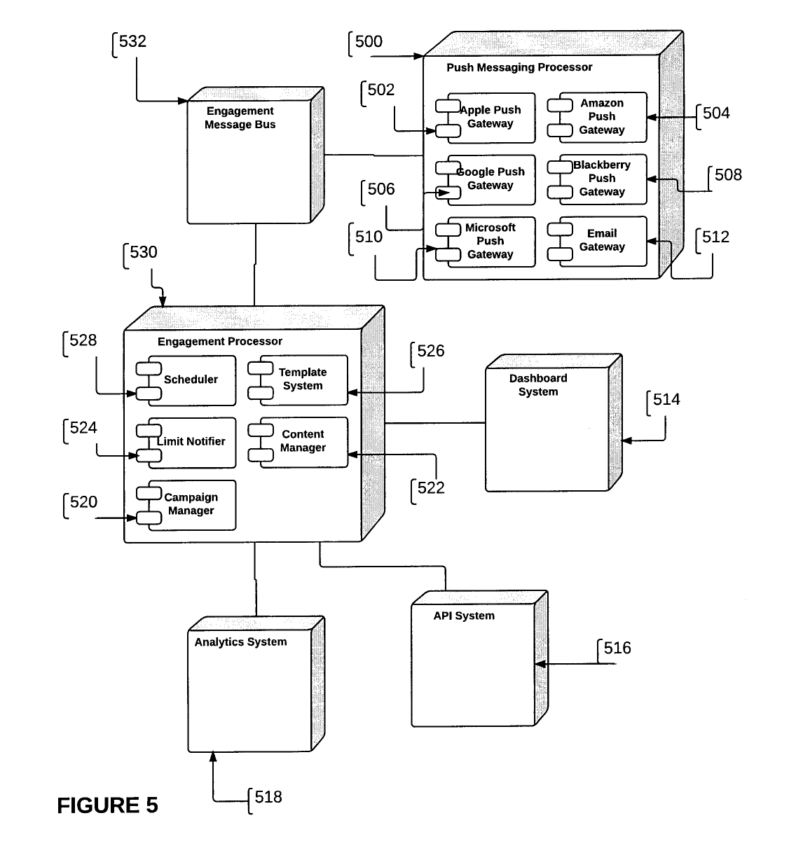

The Engagement System 304, as referenced in FIG. 5 may be provided and/or configured as a toolset application that developers may use to provide and/or define customized experiences and promote use amongst application users. The Engagement System 304 may include notification and messaging components but layers on a content management system to provide rich media and configurations applicable to specific segments of users.

The logic of whom and when to target for notifications may be embedded within the engagement system. In some embodiments, the Engagement System 304 may be configured to integrate with the analytics and dashboard systems using user created segments and cohort data for targeting.

### Engagement Processor

### Scheduler

The Scheduler 528 component may be configured for running a timer which the system can be leveraged to trigger jobs to run at specific times to send push notifications, in-app messages, or other engagement routines. The scheduler may leverage the inclusionary or exclusionary time rules set by the supervisor.

### Template System

The Template System 526 may be configured to provide the application designer with the ability to create graphical in-app messages and rich content notifications. The templates may allow localized messaging, substitution variables driven by user properties, images, custom layouts, and executable actions.

### Content Manager

The Content Manager 522 component may be configured to allow a developer to manage artistic assets leveraged by the template system as well as virtual content such as items purchasable by virtual currency. The content manager may also allow developers to define key-value pairs that may be used for setting item prices, discounts, or so on.

### Limit Notifier

The Limit Notifier 524 may be configured for triggering messages to be sent to users in regards to limit use or abuse. The notifier may, aside from formatting the message for the particular transport (e.g. email, SMS, push notification), ensure that delivery of the message may be sent during reasonable timeframes of the day to reduce late night distractions for the user.

### Campaign Manager

The Campaign Manager 520 may be configured to allow the developer to pre-create, test, and schedule series of in-app messages, pushes notifications, discounts, bonuses, and emails. A component of campaign management may be the ability to track success and conversion; to this end, additional event metrics may be captured through the analytics system and provided to the engagement system.

### Push Messaging Processor

The Push Messaging Processor 500 may configured to provide an abstraction layer giving the engagement system access to multiple channels in which users may be contacted. APIs vary between each device platform so implementations, in some embodiments, may be provided for Apple 502, Microsoft 510, Google 506, Amazon 540, and Blackberry 508 gateways.

Aside from device remote notifications the system, in some embodiments, may be configured to support email and SMS 512 gateways to either be hosted within the confines of the engagement system or using a third-party gateway provider.

### Engagement Message Bus

The Engagement Message Bus 532 may be a high performance message queue such as Kafka or RabbitMQ used to provide a measure of elasticity and reliability in between the engagement system and the push messaging processor. The Engagement Message Bus 532 may also be configured to provide a measure of protection from high message volume, peak messaging times, and inability to predict third-party gateway uptime.

### General

In further aspects, the disclosure provides systems, devices, methods, and computer programming products, including non-transient machine-readable instruction sets, for use in implementing such methods and enabling the functionality described previously.

Computers and/or computer systems may be comprised of one or more servers having one or more processors, operating in conjunction with one or more computer-readable storage media, configured to provide backend services, such as data processing, data storage, data backup, data hosting, among others.

In some embodiments, the system may be implemented using a set of distributed computing devices connected through a communications network. An example of such a set of distributed computing devices would be what is typically known as a ‘cloud computing’ implementation. In such a network, a plurality of connected devices operate together to provide services through the use of their shared resources.

A cloud-based implementation for processing and analyzing data, user information, applying rules, etc. may provide one or more advantages including: openness, flexibility, and extendibility; manageable centrally; reliability; scalability; being optimized for computing resources; having an ability to aggregate information across a number of users; and ability to connect across a number of users and find matching sub-groups of interest. While embodiments and implementations of the present disclosure may be discussed in particular non-limiting examples with respect to use of the cloud to implement aspects of the system platform, a local server, a single remote server, a software as a service platform, or any other computing device may be used instead of the cloud.

Although the disclosure may have been described and illustrated in exemplary forms with a certain degree of particularity, it may be noted that the description and illustrations have been made by way of example only. Numerous changes in the details of construction and combination and arrangement of parts and steps may be made.

Except to the extent explicitly stated or inherent within the processes described, including any optional steps or components thereof, no required order, sequence, or combination may be intended or implied. As will be will be understood by those skilled in the relevant arts, with respect to both processes and any systems, devices, etc., described herein, a wide range of variations may be possible, and even advantageous, in various circumstances.

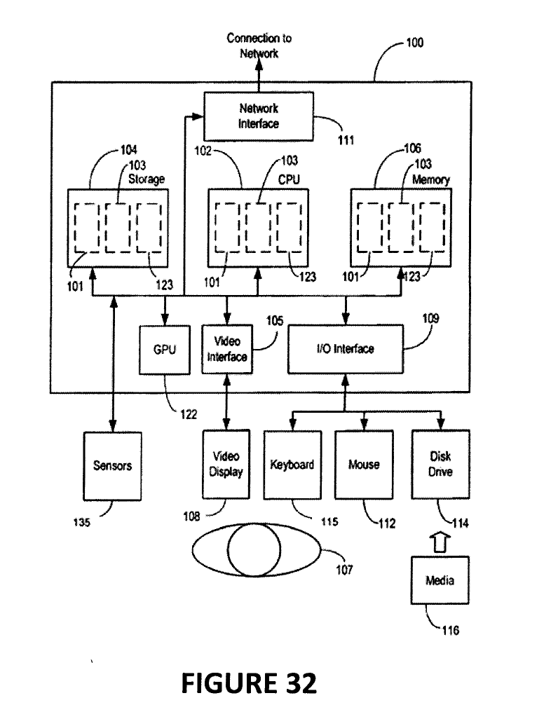

The present system and method may be practiced in various embodiments. A suitably configured computer device, and associated communications networks, devices, software and firmware may provide a platform for enabling one or more embodiments as described above. By way of example, FIG. 32 shows a computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 115, mouse 112, and disk drive or solid state drive 114 connected by an I/O interface 109. The mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 135 may be used to receive input from various sources.

The present systems and methods may be practiced on computing devices, including a desktop computer, laptop computer, tablet computer or wireless handheld.

In a particular embodiment, the present systems and methods are provided as a centralized system that may operate as part of a data center or as part of a distributed networking system, such as a cloud computing implementation having shared resources. The tracking and/or application of the system to a large number of computing endpoints is contemplated, and greater efficiencies may be provided wherein the systems and methods are provided in a centralized fashion in relation to a plurality of computing endpoints (e.g., mobile devices in use by individuals). Distributed networking solutions would be helpful as instances may be de-provisioned (e.g., spun down) and provisioned (e.g., spun up) depending on transaction volume. Dynamic load-balancing techniques may also be utilized. As a specific example, a specially configured system providing a backend solution and developed for networked communications may be contemplated for some embodiments.

The present system and method may also be implemented as a computer-readable/useable medium that includes computer program code to enable one or more computer devices to implement each of the various process steps in a method in accordance with the present disclosure. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

The mobile application of the present disclosure may be implemented as a web service, where the mobile device includes a link for accessing the web service, rather than a native application.

The functionality described may be implemented to any mobile platform, including the iOS™ platform, ANDROID™, WINDOWS™ or BLACKBERRY™.

1. A computer-implemented method for managing behaviors of at least one user of one or more electronic applications, comprising:
receiving a set of electronic instructions defining (i) one or more virtual currency limits defining constraints or permissions related to the operation of the one or more electronic applications, each virtual currency limit associated with each of the at least one user, and (ii) a set of triggers based on least one of patterns of positive gaming behavior to incentivize and patterns of negative gaming behavior to penalize;
periodically receiving, at a computing device, electronic indicia of activities performed by the at least one user associated with the one or more electronic applications;
determining, by the computing device, whether the electronic indicia of activities performed by the at least one user correspond to patterns of activity which trigger at least one of the set of triggers;
modifying the one or more virtual currency limits based at least in part in the determination that at least one of the set of triggers has been triggered;
wherein modifying the one or more virtual currency limits includes (i) increasing a virtual currency limit if the trigger triggered is associated with at least one of the patterns of behavior to incentivize, or (ii) decreasing a virtual currency limit if the trigger triggered is associated with at least one of the patterns of behavior to penalize.

2. The computer-implemented method of claim 1, further comprising:
receiving, at the computing device, electronic information representative of patterns of activity associated with an aggregate set of other users;
wherein the determining, by the computing device, whether the electronic indicia of activities performed by the at least one user correspond to patterns of activity which trigger at least one of the set of triggers includes comparing the electronic information representative of patterns of activities associated with the aggregate set of other users with the electronic indicia of activities performed by the at least one user; and
wherein the set of triggers includes at least triggers based on deviations from the patterns of activity associated with the aggregate set of other users.

3. The computer-implemented method of claim 2, further comprising:
generating one or more visual representations of patterns of activities of the one or more users compared with the electronic information representative of patterns of activities associated with the aggregate set of other users with the electronic indicia of activities performed by the at least one user; and
generating one or more visual representations of a fluctuation of the one or more virtual currency limits over a period of time.

4. The computer-implemented method of claim 1, wherein the steps of receiving a set of electronic instructions defining (i) one or more virtual currency limits defining constraints or permissions related to the operation of the one or more electronic applications, each virtual currency limit associated with each of the at least one user, and (ii) a set of triggers based on least one of patterns of positive gaming behavior to incentivize and patterns of negative gaming behavior to penalize; periodically receiving, at a computing device, electronic indicia of activities performed by the at least one user associated with the one or more electronic applications; determining, by the computing device, whether the electronic indicia of activities performed by the at least one user correspond to patterns of activity which trigger at least one of the set of triggers; and modifying the one or more virtual currency limits based at least in part in the determination that at least one of the set of triggers has been triggered; are performed by a computing device that is external to personal computing devices used by the one or more users.

5. The computer-implemented method of claim 1, further comprising:
upon receiving electronic indicia representative of a pending electronic currency transaction invoked by the one or more users, applying the one or more virtual currency limits to terminate the pending electronic currency transaction if the pending electronic currency transaction would cause a breach of one or more of the one or more virtual currency limits.

6. The computer-implemented method of claim 5, wherein the pending electronic currency transaction is an electronic transaction to purchase at least one of electronic goods and electronic services associated with the one or more applications.

7. The computer-implemented method of claim 1, further comprising:
upon receiving electronic indicia representative of a pending electronic currency transaction invoked by the one or more users, applying the one or more virtual currency limits and generating a notification for transmission to a third party computing device if the pending electronic currency transaction would cause a breach of one or more of the one or more virtual currency limits.

8. The computer-implemented method of claim 1, further comprising:
upon receiving electronic indicia representative of a pending electronic currency transaction invoked by the one or more users, applying the one or more virtual currency limits and generating a recommendation for an alternate currency transaction if the pending electronic currency transaction would cause a breach of one or more of the one or more virtual currency limits, the alternate currency transaction representing a second electronic currency transaction having a cost within the one or more virtual currency limits.

9. The computer-implemented method of claim 1, wherein the modifying the one or more virtual currency limits consists of temporarily modifying the one or more virtual currency limits based at least in part in the determination that at least one of the set of triggers has been triggered.

10. The computer-implemented method of claim 1, further comprising:
periodically providing, to a networked interface associated with the one or more electronic applications, the one or more virtual currency limits associated with the one or more users.

11. The computer-implemented method of claim 10, further comprising:
receiving, from the networked interface associated with the one or more electronic applications, a set of potential transactions having prices less than the virtual currency limit associated with one of the one or more users.

12. The computer-implemented method of claim 11, further comprising:
receiving, from the networked interface associated with the one or more electronic applications, a set of discounted potential transactions having prices less than the virtual currency limit associated with one of the one or more users.

13. The computer-implemented method of claim 1, further comprising:
periodically providing, to a networked interface associated with a centralized system managing transactions associated with the one or more electronic applications, the one or more virtual currency limits associated with the one or more users.

14. The computer-implemented method of claim 1, further comprising:
deactivating one or more user accounts associated with the one or more electronic applications, the one or more virtual currency limits associated with the one or more users.

15. The computer-implemented method of claim 1, wherein the patterns of behaviors to incentivize and the patterns of behaviors to penalize include at least patterns of usage times.

16. The computer-implemented method of claim 1, wherein the patterns of behaviors to incentivize include patterns of rationing spending.

17. The computer-implemented method of claim 16, wherein default patterns of usage times are associated with the at least one user based on at least one characteristic of the one or more users.

18. The computer-implemented method of claim 17, wherein the at least one characteristic includes at least one of age, gender, occupation, educational level and time zone.

19. The computer-implemented method of claim 1, wherein the electronic currency transactions are associated with the purchase of at least one of in-game items, in-game services, virtual statuses, game purchases, in-game currency, and unlockable products, in-app purchases.

20. A computer-implemented system for managing behaviors of at least one user of one or more electronic applications, the computer-implemented system including at least one processor and at least one non-transitory computer-readable media, the computer-implemented system residing on a computing device associated with the at least one user and the computer-implemented system comprising:
a limit monitoring unit configured for tracking at least one virtual currency limit for the at least one user, each of the at least one virtual currency limit corresponding to each of the at least one user and defining constraints or permissions related to the operation of the one or more electronic applications;
a rules program unit for generating and storing electronic rules defining track-able parameters representative of behaviors to be incentivized and behaviors to be penalized;
a behavior tracking unit configured for tracking the behaviors of the at least one user, wherein the behaviors include at least one of physical location of the computing device, power state of the computing device, most recent activity of the at least one user on the computing device, data communications usage of the computing device, and usage times of the computing devices;
a control unit configured for controlling the usage of the computing device by the at least one user by controlling at least one of the power state of the computing device, operation of the one or more electronic applications, and transactional activity on the one or more electronic applications;
wherein a rules engine is configured to periodically apply the electronic rules based at least on tracked behaviors of a user tracked by the behavior tracking unit and to periodically modify the virtual currency limit for the user; and wherein upon a breach of the virtual currency limit for the user, the control unit is configured for terminating at least one of a pending transaction, the operation of the one or more electronic applications, and the power state of the computing device.

21. (canceled)

22. (canceled)

23. (canceled)

24. (canceled)

25. (canceled)

26. (canceled)

27. (canceled)
